(19) United States
(12) Patent Application Publication
(10) Pub. No.: US 2023/0205982 A1
(43) Pub. Date: Jun. 29, 2023

(54) SYSTEMS AND METHODS FOR CLASSIFICATION OF ELEMENTS AND ELECTRONIC FORMS

(71) Applicant: Privowny France SAS, Aix-en Provence (FR)

(72) Inventor: Nguyen Hoang Nguyen, Aix-en-Provence (FR)

(21) Appl. No.: 18/089,387

(22) Filed: Dec. 27, 2022

Related U.S. Application Data
(60) Provisional application No. 63/294,048, filed on Dec. 27, 2021.

(51) Int. Cl. G06F 40/174; G06V 30/412; G06V 30/413

(52) U.S. Cl. CPC G06F 40/174; G06V 30/412; G06V 30/413

(57) ABSTRACT

A processing server identifies one or more classifications of an electronic form. The processing server includes one or more hardware processors and memory storing computer instructions, the computer instructions when executed by the one or more hardware processors, extract information from raw source code and contextual information of an electronic form, based on the extracted information, infer the one or more classifications of elements on the electronic form, based on the inferred one or more classifications of elements, infer a classification of the electronic form, suggest a downstream action based on the inferred classifications of the elements and the inferred classification of the electronic form, and selectively performing the downstream action.

### CROSS REFERENCE TO RELATED APPLICATION

This application claims the benefit of U.S. Provisional Application Serial No. 63/294,048, entitled “System and Method For Identifying Forms And Fields Using Machine Learning,” filed Dec. 27, 2021, which is incorporated by reference in its entirety herein for all purposes.

### TECHNICAL FIELD

This invention relates generally to computer systems, and more particularly provides systems and methods for classifying electronic forms and elements such as fields.

### BACKGROUND

Electronic forms, such as login, signup, search, payment, feedback, contact and support forms, have proliferated. These forms may provide functions such as querying, extracting, populating, uploading, storing and/or providing information. In order to utilize and process these forms, fields and other elements on the form need to be accurately detected and classified. Due to the prevalence and variety of different electronic form types, the automated processing of such forms is a nontrivial but pressing conundrum, as market share in the form automation software market has increased from approximately $7 billion in 2018 to an estimated $26 billion in 2026, according to Verified Market Research.

### SUMMARY

In order to efficiently and accurately process an electronic form, accurately inferring or predicting (hereinafter “inferring”) element types and/or classifications (hereinafter “classifications”) within an electronic form and classifying the electronic form as a whole is a precursor. In particular, the inferring of element classifications and the electronic form as a whole may encompass extracting or obtaining both visual elements or aspects within the electronic form and nonvisual elements, such as coding (e.g., HyperText Markup Language (HTML) coding) and/or metadata underlying the electronic form. One or more machine learning components or models (hereinafter “components”) may output one or more probabilities corresponding to one or more element classifications and/or form classifications. Here, an element may include, as nonlimiting examples, graphical user interface or graphical control elements (e.g., Document Object Model (DOM) or HTML elements or child elements or nodes thereof), such as fields, boxes, buttons, menus, lists and tabs, and more specifically, text fields, checkboxes, radio buttons, submit buttons, other clickable buttons, toggle switches, pull-down tabs, drop down menus and lists. Based on the probabilities, a computing system may suggest, perform or implement one or more other downstream actions such as populating information within one or more elements, storing or uploading, within a local client device, information within the one or more elements, conducting a search to return any results or matches, submitting or transmitting the populated information, determining one or more updates to the electronic form, and/or initiating one or more electronic or physical processes. In such a manner, the inferring of electronic form and field classifications may be performed on a gamut of different form and field types, and further applied to non-static fields and forms.

In some embodiments, the present invention provides a processing server configured to identify one or more classifications of an electronic form. The processing server system comprises one or more hardware processors and memory storing computer instructions. The computer instructions, when executed by the one or more hardware processors, are configured to perform extracting information from raw source code and contextual information of an electronic form; based on the extracted information, inferring the one or more classifications of elements on the electronic form; based on the inferred one or more classifications of elements, inferring a classification of the electronic form; suggesting a downstream action based on the inferred classifications of the elements and the inferred classification of the electronic form; and selectively performing the downstream action.

In some embodiments, the extracting of information further comprises extracting metadata of the electronic form, the metadata indicating previous versions or a lineage of the electronic form.

In some embodiments, the computer instructions, when executed by the one or more hardware processors, are configured to perform determining one or more probabilities corresponding to the one or more inferred classifications of elements and the inferred classification of the electronic form.

In some embodiments, the downstream action comprises autofilling or autocompleting one or more of the elements.

In some embodiments, the contextual information comprises any textual features and media components within the electronic form, and relative positions of the any textual features and media components.

In some embodiments, the contextual information comprises inferred or verified classifications of previous elements or forms of an immediately preceding form, wherein the immediately preceding form, following submission, populates the electronic form.

In some embodiments, the inferring of the intent is performed by a trained machine learning component.

In some embodiments, the computer instructions, when executed by the one or more hardware processors, are configured to perform: detecting an update to the electronic form, the update comprising a new or modified element; extracting information from raw source code and contextual information of the new or modified element; based on the extracted information, inferring one or more classifications of the new or modified element; based on the inferred one or more classifications of the new or modified element, inferring an updated classification of the electronic form; suggesting a second downstream action based on the inferred classifications of the new or modified element and the updated classification of the electronic form; and selectively performing the second downstream action.

In some embodiments, the update to the electronic form is responsive to a change in an entity being monitored or tracked by the electronic form.

In some embodiments, the update to the electronic form comprises an automatic switch between different versions of the electronic form at particular time intervals.

In some embodiments, the update to the electronic form is in response to a user input or a user action within the electronic form.

In some embodiments, the inferring of the one or more classifications of elements on the electronic form and the inferring of the classification of the electronic form are performed using one or more machine learning components, and the machine learning components are trained iteratively, using a first training dataset comprising previously inferred or verified classifications of elements and forms and a second training dataset comprising incorrectly inferred classifications of elements and forms by the machine learning components following the training using the first training dataset.

In some embodiments, the present invention provides a processing server configured to identify one or more classifications of an electronic form. The processing server system comprises one or more hardware processor and memory storing computer instructions. The computer instructions when executed by the one or more hardware processors are configured to perform distributing a plugin to a client device, the plugin comprising a machine learning component that classifies one or more elements within an electronic form and classifies the electronic form; receiving feedback from the client device regarding a performance of the machine learning component; transmitting an indication to perform further training on the machine learning component based on the received feedback; obtaining an updated machine learning component based on the further training; and distributing a plugin having the updated machine learning component to the client device.

In some embodiments, the feedback comprises erroneous inferences of classifications of elements or erroneous inferences of classifications of the electronic form.

In some embodiments, the computer instructions, when executed by the one or more hardware processors, are configured to perform: storing a trained machine learning component within the processing server system; and wherein the distributing of the plugin comprises determining or obtaining one or more storage or processing attributes or constraints of the client device; and selectively downscaling the machine learning component relative to the stored trained machine learning component based on the one or more storage or processing attributes or constraints of the client device.

In some embodiments, the present invention provides a client device configured to identify one or more classifications of an electronic form. The client device comprising one or more hardware processors and memory storing computer instructions. The computer instructions when executed by the one or more hardware processors configured to perform: receiving a plugin, the plugin comprising a machine learning component that classifies one or more elements within an electronic form and classifies the electronic form; and executing the plugin, wherein the executing of the plugin comprises: extracting information from raw source code and contextual information of an electronic form; based on the extracted information, inferring the one or more classifications of elements on the electronic form; based on the inferred one or more classifications of elements, inferring a classification of the electronic form; suggesting a downstream action based on the inferred classifications of the elements and the inferred classification of the electronic form; and selectively performing the downstream action.

In some embodiments, the extracting of information further comprises extracting metadata of the electronic form, the metadata indicating previous versions or a lineage of the electronic form.

In some embodiments, the computer instructions, when executed by the one or more hardware processors, are configured to perform determining one or more probabilities corresponding to the one or more inferred classifications of elements and the inferred classification of the electronic form.

In some embodiments, the downstream action comprises autofilling or autocompleting one or more of the elements.

In some embodiments, the contextual information comprises any textual features and media components within the electronic form, and relative positions of the any textual features and media components.

### BRIEF DESCRIPTION OF THE DRAWINGS

FIG. 1 is a block diagram of an element and electronic form classification network, in accordance with some embodiments of the present invention.

FIG. 2A is a block diagram of a processing server that performs an inference of a classification of an element within an electronic form and of the electronic form, in accordance with some embodiments of the present invention.

FIG. 2B is a block diagram of an information extraction engine within the processing server configured to extract or obtain relevant information to perform the inferences of the element and the electronic form, in accordance with some embodiments of the present invention.

FIG. 3 is a diagram illustrating details of performing inferences of elements and an electronic form classified as a login form, in accordance with some embodiments of the present invention.

FIG. 4 is a diagram illustrating details of performing inferences of elements and an electronic form classified as a payment form, in accordance with some embodiments of the present invention.

FIG. 5A is a diagram illustrating details of performing inferences of elements and an electronic form classified as an authentication form, in accordance with some embodiments of the present invention.

FIG. 5B is a diagram illustrating details of performing inferences of elements and an electronic form classified as a reset and change password form, in accordance with some embodiments of the present invention.

FIG. 6 is a diagram illustrating details of performing inferences of elements and an electronic form classified as a search form, in accordance with some embodiments of the present invention.

FIG. 7 is a diagram illustrating details of suggesting and/or performing a downstream action to avoid a time-out of an electronic form, in accordance with some embodiments of the present invention.

FIG. 8 is a diagram illustrating details of detecting updates to an electronic form, in which the electronic form switches between different versions or representations, in accordance with some embodiments of the present invention.

FIG. 9 is a diagram illustrating details of detecting updates to an electronic form, in which an action causes or results in populating of new elements, in accordance with some embodiments of the present invention.

FIG. 10 is a diagram illustrating details of detecting spurious or unintended elements within an electronic form, in accordance with some embodiments of the present invention.

FIG. 11 is a diagram illustrating details of detecting updates to an electronic form, in which updates of entities being tracked within the electronic form cause or result in populating of new elements, in accordance with some embodiments of the present invention.

FIG. 12 is a diagram illustrating details of detecting updates to an electronic form, in which new entities being tracked within the electronic form cause or result in populating of new elements, in accordance with some embodiments of the present invention.

FIG. 13 is a diagram illustrating details of detecting updates to an electronic form, in which changes to entities being tracked within the electronic form cause or result in populating of new elements, in accordance with some embodiments of the present invention.

FIG. 14 is a block diagram illustrating details of iterative training of machine learning components, in accordance with some embodiments of the present invention.

FIG. 15 is a diagram illustrating details of iterative training of machine learning components, in accordance with some embodiments of the present invention.

FIG. 16 is a block diagram of a client device, in which the client device, rather than an external processing server, locally performs inferences of classifications of elements and forms, in accordance with some embodiments of the present invention.

FIG. 17 is a block diagram of a processing server that distributes one or more machine learning components and processors to a client device, consistent with FIG. 16, in accordance with some embodiments of the present invention.

FIG. 18 is a flowchart illustrating details of a method of inferring one or more classifications of one or more elements within an electronic form and one or more classifications of the electronic form itself, in accordance with some embodiments of the present invention.

FIG. 19 is a flowchart illustrating details of a method of distributing one or more machine learning components and processors to a client device, in accordance with some embodiments of the present invention.

FIG. 20 is a block diagram illustrating details of a computing system.

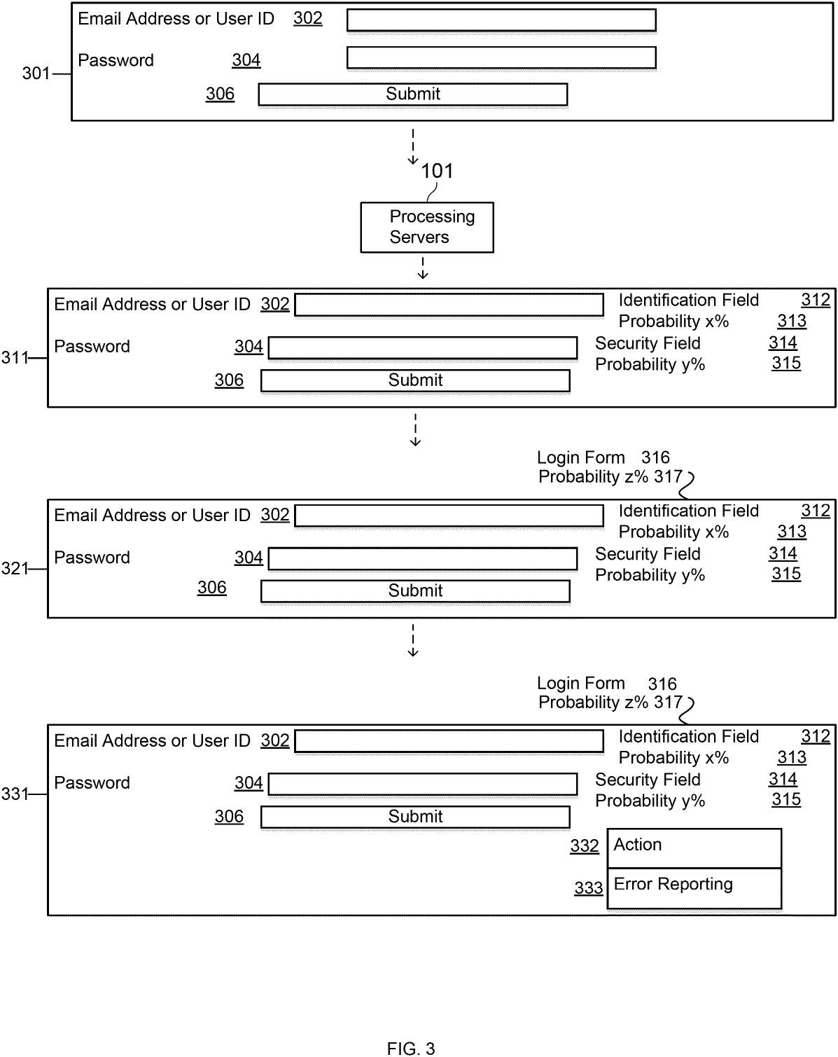

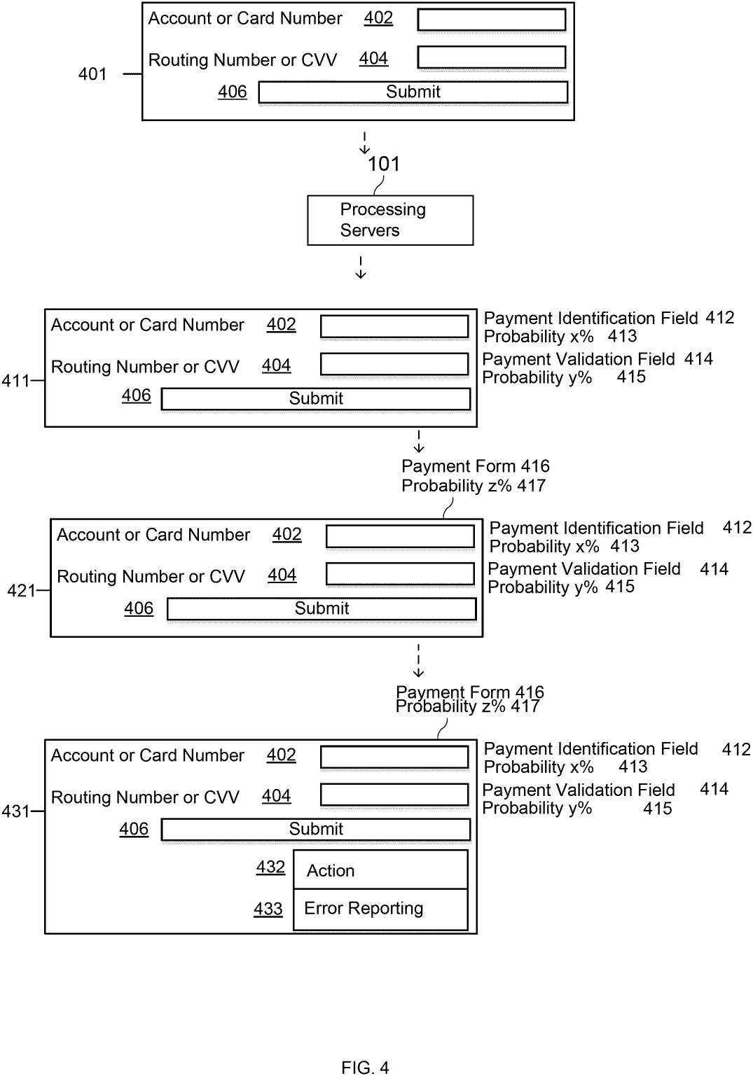

Any relevant principles in any of the FIGS. may be applicable to other FIGS. For example, any relevant principles in FIG. 3 may be applicable to FIGS. 4, 5A, 5B, and 6-13.

### DETAILED DESCRIPTION

The following description is provided to enable a person skilled in the art to make and use various embodiments of the invention. Modifications are possible. The generic principles defined herein may be applied to the disclosed and other embodiments without departing from the spirit and scope of the invention. Thus, the claims are not intended to be limited to the embodiments disclosed, but are to be accorded the widest scope consistent with the principles, features and teachings herein.

A server, processor, or computer (hereinafter “processor”) may include and deploy one or more processes to predict, infer, or determine one or more classifications of respective elements within an electronic form, using one or more machine learning components. To perform such an inference, the processor may first extract or obtain metadata, coding, and/or contextual information associated with the elements. An element may include, as nonlimiting examples, graphical user interface or graphical control elements (e.g., DOM or HTML elements), such as fields, boxes, buttons, menus, lists and tabs, such as text fields, checkboxes, radio buttons, submit buttons, other clickable buttons, pull-down tabs, drop down menus and lists. In some examples, the coding may include HTML coding underlying the electronic form. Meanwhile, the metadata may include, for example, a version and/or a history associated with the one or more processes. The contextual information may include classifications of other elements within a same electronic form and/or one or more previous electronic forms, including a preceding electronic form (e.g., an immediate preceding electronic form) or a subsequent electronic form (e.g., an immediate subsequent electronic form), positions of the elements with respect to other elements, and/or words, symbols, or other media components (e.g., images, audio, video) within the electronic form and/or relative positions thereof. An immediate preceding electronic form (hereinafter “form”) may be a form that, after submission of information, resulted in generation of a current form for which classifications are being inferred. If the electronic form resides on, or is stored on, a webpage, which may be represented as a website including a domain name and a path, then a preceding electronic form may reside on, or be stored on, a webpage that is represented as a website that includes the domain name without a path. An immediate subsequent electronic form may be a resulting form generated or populated following submission of information on the current form. From the inference of the classifications of the elements, the processor may subsequently infer a classification of the form as a whole.

In some examples, the processor may be deployed externally from a client device on which the form resides. The electronic form, and/or relevant information thereof, may be transmitted from the client device to the processor. Thus, the client device may be connected and/or subscribed to the processor. Once the processor performs the inferences and/or other downstream functions such as populating fields, any outputs or results are fed back or transmitted back to the client device. In other examples, additionally or alternatively, an instance of the processor may be transmitted or distributed to, and/or deployed on the client device itself, which obviates a need for a client device to remotely connect to the processor while running the processes to perform inferences and other downstream actions. A condensed or simplified version of the processor may be deployed on the client device. An extent to which the processor is condensed or simplified may depend on available bandwidth, stability, and/or speed of a network, and/or computing storage availability or other computing parameters of the client device itself. Here, condensed or simplified may mean that a subset of the features of the original processor are reduced, curtailed, or eliminated to save storage space and/or processing resources. For example, machine learning components within or associated with the processor may be trained to a reduced extent.

The one or more machine learning components associated with the processor may obtain input information including metadata, coding, and/or contextual information associated with the elements, and output an inference of element classifications, and/or electronic form classifications. The machine learning components may be trained using one or more sets of training data, which may encompass previously inferred or verified classifications of elements and previously inferred or verified classifications of electronic forms, and parameters or attributes of the previously inferred or verified elements and electronic forms. The training may include multiple stages. For example, in a first stage, a first subset of data including previously inferred or verified elements and electronic forms may be obtained or collected from a database, either manually or automatically. Only a portion of previously inferred or verified elements and electronic forms from the database may be used for training. A remainder of such information from the database may be utilized for subsequent testing and/or validation. Information from the first subset of data may be curated and/or normalized. For example, terminology, syntax, symbols, and/or accent marks may be normalized. One particular example is that if one electronic form refers to “log in” as two separate words but another electronic form refers to “login” as a single word, then the processor may apply a uniform classification across all such fields and/or electronic forms, either referring to “login” as a single word or “log in” as two separate words. A first training set may include the first subset prior to normalization and/or after normalization. Following training of the machine learning components using the first training set, the machine learning components may generate one or more inferences and probabilities thereof. Additionally or alternatively, a second training set may be created for a second stage of training. The second training set may include the first training set, any incorrect inferences following the first stage of training, and/or any updates to the inferences. In other words, the second training set may encompass feedback data. Infrastructure and mechanisms for accurately inferring element and electronic form classifications, implementing a downstream action in accordance with the inferred classification, and training a machine learning component to accurately infer the classifications, are illustrated in the figures herein.

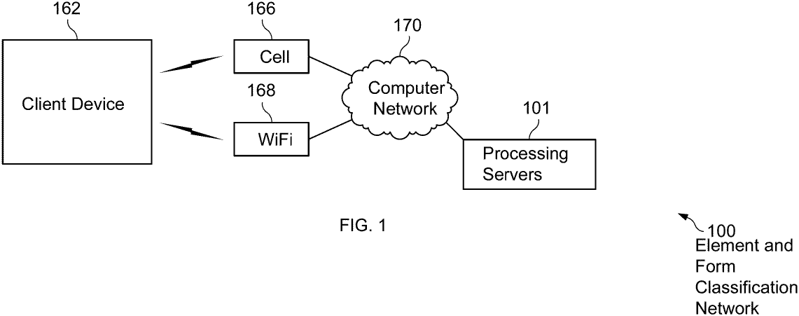

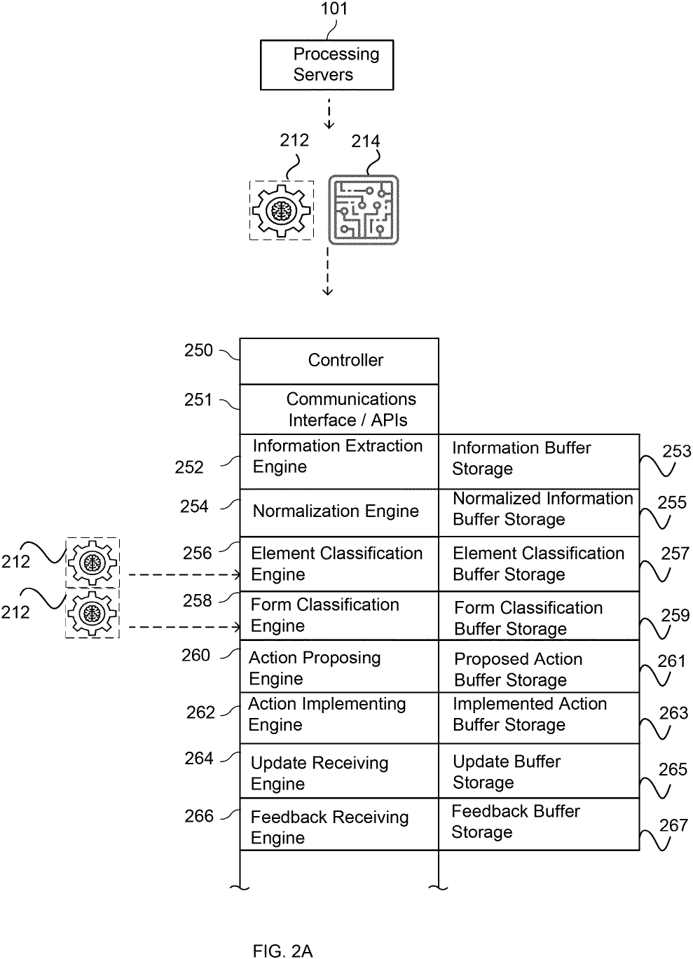

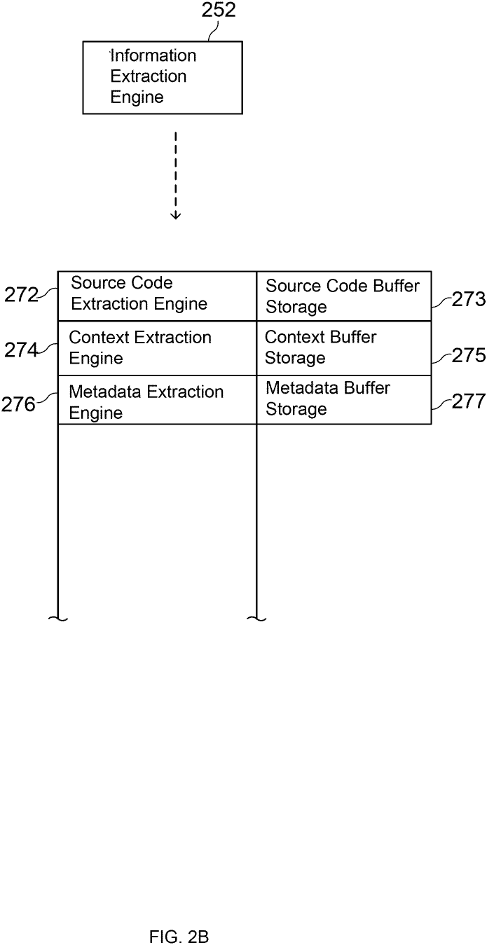

FIG. 1 is a block diagram of an element and form classification network 100, in accordance with some embodiments of the present invention, in which one or more processing servers 101 may infer classifications of elements and/or forms, or otherwise facilitate the inference thereof. In some examples, the processing servers 101 may receive a query, request, or indication (hereinafter “query”) from a client device 162 regarding a form, as illustrated in FIGS. 2A-2B. In such a manner, the client device 162 may connect remotely to the processing servers 101. The processing servers 101 may obtain, via transmission by the client device 162, or otherwise extract, metadata, contextual information, and/or coding underlying the form. Additionally or alternatively, the processing servers 101 may distribute, transmit, or upload a version of a package including functionalities of the processing servers 101, as illustrated in FIGS. 3-4. In such a manner, the client device 162 does not require a remote connection to the processing servers 101 to perform inferences, but rather, may perform the inferences locally.

The client device 162 may be coupled via a cellular channel 166 and/or a WiFi channel 168 to a computer network 170, which is connected to the processing servers 101. The WiFi channel 168 may encompass technologies such as home WiFi, public WiFi, WiFi (Wireless Fidelity), BLE (Bluetooth Low Energy), and IEEE (Institute of Electrical and Electronics Engineers) 802.15.4 protocols such as Zigbee (Zonal Intercommunication Global-standard, where Battery life is long, which is Economical to deploy, and which exhibits Efficient use of resources), ISA100.11a (Internet Society of Automation 100.11a), WirelessHART (Highway Addressable Remote Transducer Protocol), MiWi (Microchip Wireless), 6LoWPAN (IPv6 over Low-Power Wireless Personal Area Networks), Thread, and SNAP (Subnetwork Access Protocol), and/or the like). The client device 162 may be any smart device such as laptop, mobile phone, tablet, desktop computer, car entertainment/radio system, game console, smart television, set-top box, smart appliance or general edge-computing device. The computer network 110 may include any wide area network, local area network, wireless area network, private network, public network and/or the particular wide area network commonly referred to as the Internet. The one or more processing servers 101 may be one or more computer device capable of processing the information captured by the client device 162 (and other similar client devices of other users).

FIG. 2A is a block diagram of the one or more processing servers 101 that performs an inference of a classification of an element within an electronic form and of the electronic form, in accordance with some embodiments of the present invention. The processing servers 101 may be located remotely from the client device 162. The processing servers 101 may encompass one or more machine learning components 212 and one or more processors 214. The processors 214 may be physical or virtual entities. For example, as virtual entities, the processors 214 may be encompassed within, or manifested as, a program or package within a cloud environment. More specifically, the processing servers 101 may include a controller 250, a communications interface and application programming interfaces (APIs) 251, an information extraction engine 252, a normalization engine 254, an element classification engine 256, a form classification engine 258, an action proposing engine 260, an action implementing engine 262, an update receiving engine 264, and a feedback receiving engine 266, and/or information buffer storage 253, normalized information buffer storage 255, element classification buffer storage 257, form classification buffer storage 259, proposed action buffer storage 261, implemented action buffer storage 263, update buffer storage 265, and feedback buffer storage 267.

The controller 250 includes hardware, software and/or firmware configured to control the process and functionalities of the processing servers 101. The controller 250 is configured to manage general operations as well as monitor and manage the other services, such as inference services, implementation services, machine learning component training services, data management or storage services and notification services. The controller 250 is configured to manage configuration and state information, as well as establish channels to the components within itself, to running the other services, and to interactions with one or more entities, such as an end user. For example, the controller 250 may use the communications interface and APIs 251 to identify when storage is running low, to shut down any services that are occupying storage, or any services occupying highest amounts or rates of storage, to provide a notification, for example, to a user (e.g., of the processing servers 101, or of the client device 162), when a network connection is unstable or otherwise compromised (e.g., when a degree of stability, network bandwidth, and/or speed decreases below a threshold), when storage is getting low (e.g., below a threshold storage level) and when some of the captured data should be offloaded, to identify when battery of, or associated with, the processing servers 101 and/or the controller 250 is running low, to shut down any services that might be draining the battery, to provide a notification, for example, to a user, that due to low battery data capture services have been temporarily stopped until recharged, to identify a health and/or stability of the processing servers 101 and/or the controller 250 and data capture services, to detect a state or status of the processing servers 101 and/or the controller 250, available resources, permissions available and/or the like, to control restarting of the processing servers 101 and/or the controller 250 and/or other services, to prompt the user when permissions have changed or need to be refreshed, and/or to support certain optimizations as discussed below.

The communications interface and APIs 251 include hardware, software and/or firmware configured to enable the processing servers 101 (e.g., the controller 250, information extraction engine 252, a normalization engine 254, an element classification engine 256, a form classification engine 258, an action proposing engine 260, an action implementing engine 262, an update receiving engine 264, and a feedback receiving engine 266). ) to communicate with other components, such as the client device 162 from which a query or other indication is received, and/or relevant information to make an inference is obtained. The controller 250 may further distribute or transmit updates to the client device 162.

The information extraction engine 252 may include hardware, software and/or firmware configured to use the communications interface and APIs 251 to obtain or extract (hereinafter “extract”) information from the electronic form on the client device 162 and for which the client device 162 is querying, requesting, or otherwise indicating to perform inferences and/or process. As described and illustrated in FIG. 2B, the information may include visible elements such as contextual information and invisible elements such as coding (e.g., HTML coding) used to generate and/or operate the form and/or of a webpage hosting the form, and metadata (e.g., version and/or history of an electronic form).

The information buffer storage 253 may include hardware, software and/or firmware configured to store information obtained by the information extraction engine 252. The information buffer storage 253 may store the information, and/or other associated information, into respective buffer slots in the information buffer storage 253. For example, the information buffer storage 253 may store the sequential inferences in the respective buffer slots in a temporal order (e.g., according to times or timestamps of the information). This information may include visible elements and invisible elements. More specifically, the visible elements may include the contextual information, which may include classifications and/or relative positions of other elements within a same electronic form and/or one or more previous electronic forms, including an immediate preceding or an immediate subsequent electronic form, and/or words, symbols, or other media components (e.g., images, audio, video) within the electronic form and/or relative positions thereof. An immediate preceding electronic form (hereinafter “form”) may be a form that, after submission of information, resulted in generation of a current form for which classifications are being inferred. For example, if, following completion and submission on a login page, a search page was populated as a result, then the login page immediately precedes the search page. An immediate subsequent electronic form may be a resulting form generated or populated following submission of information on the current form. For example, if, following completion and submission of a search page, a results page was populated as a result, then the search page immediately precedes the results page. Meanwhile, the invisible elements may include coding of the electronic form and/or of the webpage underlying the electronic form. The coding may indicate whether an element is permanent, or temporary or dynamic, whether an element was intended to be part of the form or a spurious element from an external or third-party source (e.g., spam), classifications (e.g., fields, boxes, buttons, menus, lists and tabs), and/or relative positions of the elements. The classifications and/or relative positions indicated by the coding may further confirm or verify the contextual information.

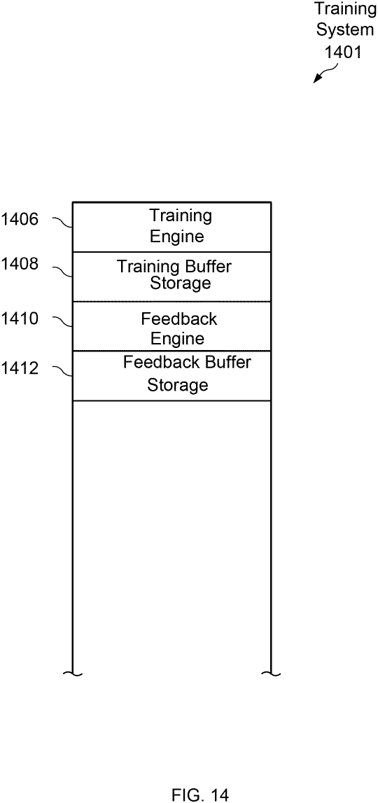

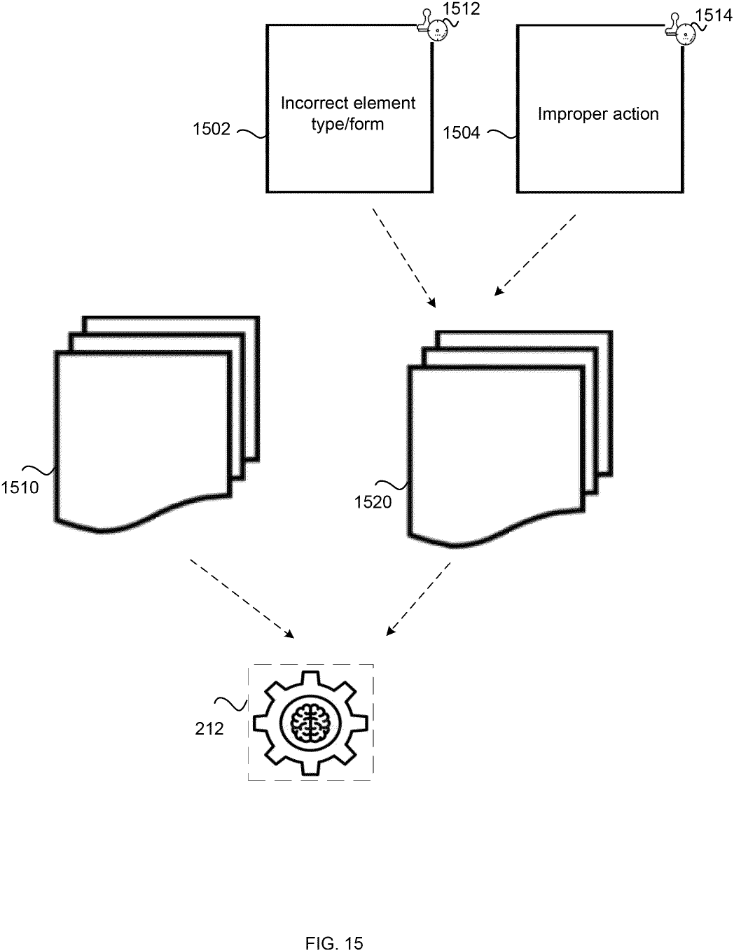

This stored information may be normalized and/or standardized by the normalization engine 254. The normalization engine 254 may include hardware, software and/or firmware configured to normalize and/or standardize a format, terminology, style and/or syntax, of the information, for example, in textual format. As specific examples, diacritics such as accent marks or other marks may be removed, and certain words may be concatenated (such as “log in or log-in” being transformed to “login”) so that specific entities are uniformly referred to, in particular languages, which expedites and increases accuracy of subsequent processing and/or performing inferences. The normalization engine 254 may recognize, standardize, and/or process information in different languages and/or styles. The different languages may include, as nonlimiting examples, English, Spanish, and/or French. The different styles may include camel case, mixed case, and pascal case. The processing of the information may encompass Viterbi segmentation to determine a most likely string of text. Similar or same principles may also apply to normalizing and/or standardizing training datasets prior to actually training the machine learning components 212, as will be described in FIGS. 14-15. The normalized information buffer storage 255 may include hardware, software and/or firmware configured to store the normalized information.

The element classification engine 256 may include hardware, software and/or firmware configured to utilize, deploy, or leverage the one or more machine learning components 212 to infer an entity’s intent regarding whether or not the entity desires to be opted out of receiving messages. The entity may be associated with the client device 162. For example, the entity may be a user of the client device 162. The machine learning components 111 may include any of random forest models, regression (e.g., heuristic regression), Markov models, decision trees, and/or other supervised techniques, such as, without limitation, neural networks, perceptrons, Support Vector Machine (SVM), classification, Bayes, k-nearest neighbor (KNN), and/or gradient boosting models. The element classification engine 256 may infer classifications of elements within the form based on both the visible and invisible features within the form. Here, the elements may include entities within the form, such as fields, boxes, buttons, menus, lists and tabs, and more specifically, text fields, checkboxes, radio buttons, submit buttons, other clickable buttons, toggle switches, pull-down tabs, drop down menus and lists. The element classification engine 256 may infer one or more classifications and respective probabilities, or confidence levels thereof. For example, the element classification engine 256 may infer that a particular element is a payment verification field with 99 percent probability and an identity verification field with a 1 percent probability. In performing the inference, the element classification engine 256 may determine whether any text corresponding to or surrounding an element corresponds to a keyword, which may indicate or suggest that the element is or is not characterized as a particular classification, and/or a count or frequency of appearance of keywords, either positive or negative. For example, a keyword “city” may be associated with an address field, indicating that a field is to be characterized or classified as an address field, but a keyword “telephone” may indicate that a field is not to be classified as an address field. For example, the keyword “city” may be referred to as a positive keyword while the keyword “telephone” may be referred to as a negative keyword in a context of an address field. However, in other contexts, such as in a contact information field, the keyword “city” may be referred to as a negative keyword while the keyword “telephone” may be referred to as a positive keyword. Generally, a higher a count or frequency of positive keywords, in a context of a particular element type (e.g., field), the more likely that the element is characterized or classified as the particular element type. A higher a count or frequency of negative keywords, in the context of the particular element type, the less likely that the element is characterized or classified as the particular element type. The element classification engine 256 may further infer a classification based on other elements within a same form, any child elements or nodes belonging to the element, and/or other elements on other preceding forms, such as an immediately preceding form. For example, the element classification engine 256 may leverage common, established, and/or frequently occurring sequential relationships among forms and/or fields such as a name field typically being on a same page as a contact field (e.g., email address and/or telephone number) to infer, or verify, classifications of certain elements. Another such relationship may be that an identification form immediately precedes, or precedes, a payment form. Thus, if the element classification engine 256 infers that a particular form contains fields that correspond to or are appropriate for a payment form, which follows fields that correspond to an identification form in a previous form, the element classification engine 256 may corroborate the inference or increase its confidence level or probability of the inference. Additionally, the element classification engine 256 may utilize metadata, such as previous classifications in one or more previous versions and/or historical classifications of elements of a form, to either corroborate its inference or instruct an inference of an otherwise unknown or uncertain classification. The element classification engine 256 may further determine or verify whether an element is an actual element that was intended to be part of a form, for example, from the source code of the form, or is a spurious or unintended element (e.g., from spam or malware). One such example is a spurious payment field requesting payment within a search form that includes search query fields or elements. The element classification engine 256 may further corroborate its inference based on detection of irregular patterns or detections, for example, numerous email fields in a same form. Therefore, if the element classification engine 256 initially infers numerous email fields, then the element classification engine 256 may reperform an inference of one or more of the previously inferred email fields to infer a different classification such that only a single email field is inferred within the same form.

The element classification buffer storage 257 may include hardware, software and/or firmware configured to store information regarding the one or more inferred element classifications, such as, a type of the element (e.g., fields, boxes, buttons, menus, lists and tabs), a specific classification of the element (e.g., address field, name field, payment verification field) and a corresponding probability, specific inputs and formats accepted or requested by the element, in particular, whether the element requests a textual, and/or media component, such as an image, video, or audio component (e.g., file), specific file formats (e.g., Joint Photographic Experts Group (JPEG), Portable Network Graphics (PNG)) permitted, and/or whether the element was originally part of the form or was an unintended or spurious element from a third party (e.g., spam). Additionally, the element classification buffer storage 257 may store information regarding a time or timestamp of the inferred element classifications.

The form classification engine 258 may include hardware, software and/or firmware configured to leverage the one or more machine learning components 212 to infer a classification of the form, and a probability or confidence level thereof, based on inferred classifications of the elements within the form, as inferred from the element classification engine 256. Furthermore, the form classification engine 258 may infer a classification of the form based on relative positions of the elements, inferred or confirmed classifications of elements within one or more previous or preceding forms, and/or inferred or confirmed classifications of the one or more previous or preceding forms. Particular elements and/or keywords may be mapped to specific classifications of forms. For example, a bank account field, a bank routing number field, and a credit card number field may be associated with a payment form, but a search query field may be associated with different forms besides a payment form. The form classification engine 258 may exclude spurious or unintended elements from the inference of the form classification. For example, if the element classification engine 256 inferred an existence of search query fields or elements within a form, and detected a spurious payment field requesting payment, the spurious payment field would be excluded from factoring in the inference. In some examples, a determination or inference by the form classification engine 258 may be used to inform or confirm inferences of elements by the element classification engine 256. For example, if the form classification engine 258 infers that a form is a search form, but the element classification engine 256 inferred an element within the form as an identity verification field, which is not mapped to or associated with a search form, the element classification engine 256 may repeat an inference of that element to verify a classification of that element. However, if the element classification engine 256 still infers that the element is an identity verification field, then the element classification engine 256 may retain or keep its previous inference.

The form classification buffer storage 259 may include hardware, software and/or firmware configured to store one or more inferred classifications of the forms, respective probabilities or confidence levels thereof, and/or respective times or timestamps of the inferences.

The action proposing engine 260 may include hardware, software and/or firmware configured to propose or suggest one or more actions based on the inferences of elements and/or forms. For example, the proposed actions may include autofilling or autocompleting a field, or retrieving a particular file such as a media component (e.g. audio, video, or image). The action proposing engine 260 may propose retrieving, locally from the client device 162, any saved information such as entries (e.g., saved identity or verification information such as credit card numbers, usernames, account numbers, or passwords) for autofilling or autocompletion, and/or particular files for input (e.g., copies of identification cards such as driver’s licenses, images or videos of a person, audio recordings of a person). For security, any such saved information may be encrypted in transit and at rest, for example, within the processing servers 101. Other actions may include, preventing an electronic form from timing out, initiating one or more electronic or physical processes such as storing or recording information and/or actions locally within the client device 162, or at one or more external processors, selectively initiating or transmitting an alert, flag, or command (e.g., to perform some physical action) to the client device 162 or to one or more external processors.

The proposed action buffer storage 261 may include hardware, software and/or firmware configured to store the proposed or suggested one or more actions, respective times or timestamps thereof, and/or indications of whether the respective one or more actions were actually implemented.

The action implementing engine 262 may include hardware, software and/or firmware configured to selectively implement the one or more actions proposed by the action proposing engine 260, and/or other actions. In some examples, the action implementing engine 262 may automatically implement one or more proposed actions, or may implement such proposed actions only upon approval by a user. For example, a user associated with the client device 162 may indicate to decline or reject the one or more actions and select a different action to implement. Upon implementing an action, if the action implementing engine 262 receives an indication of an error, then the action implementing engine 262 may transmit the indication to the action proposing engine 260 to propose a different action, or to the element classification engine 256 to repeat an inference of an element corresponding to which the action was implemented. For example, the action implementing engine 262 may have implemented an autofill for a physical address of a user, which returned an error. Upon transmitting such indication to the action proposing engine 260 or to the element classification engine 256, the action proposing engine 260 may propose an autofill of a different physical address, or an electronic mail address instead, or the element classification engine 256 may reclassify the element as an electronic mail address field rather than a physical address field. The action implementing engine 262 may then implement autofill of a different physical address or an electronic mail address instead.

The implemented action buffer storage 263 may include hardware, software and/or firmware configured to store the implemented one or more actions, respective times or timestamps thereof, whether the implemented one or more actions matched a proposed action by the action proposing engine 260, and/or whether the implemented one or more actions returned or resulted in an error. If the implemented one or more actions returned or resulted in an error, the implemented action buffer storage 263 may further indicate any troubleshooting measures to resolve the error, such as any different actions proposed and/or implemented and/or reclassifications, and whether such troubleshooting measures resolved the error.

The update receiving engine 264 may include hardware, software and/or firmware configured to receive one or more updates or changes to elements and/or forms. For example, updates may include changes in dynamic forms, such as, a form changing between different representations, versions, or displays, either automatically or upon certain input. For example, a form may be updated to populate additional elements such as fields upon submission of certain information. Specifically, a field, tab, or menu may prompt an input of a state, province, or other region upon entry of a country such as the United States. In other examples, a form may change automatically between two representations at a given frequency, such as, a form switching, at a given interval, between a search query form and a results form indicating one or more results of a search query. In other examples, a form may populate fields upon occurrence of one or more events, such as, via tracking one or more given entities that satisfy certain parameters or characteristics, and/or one or more user actions such as a user hovering over a specific element or region of the form, and/or clicking on a specific element or region of the form. In response to the update receiving engine 264 obtaining an indication of an update, the update receiving engine 264 may either transmit such indication to the element classification engine 256 and/or to the form classification engine 258 to reprocess one or more inferences. Alternatively, if a form changes automatically, at a given interval, and switches between one or more representations, then the inferences made by the element classification engine 256 and the form classification engine 258 may be locally stored within the client device 162 and may be retrieved, so that the element classification engine 256 and the form classification engine 258 need not reperform inferences.

The update buffer storage 265 may include hardware, software and/or firmware configured to store the one or more updates to the elements and/or forms, times or timestamps thereof, and/or whether the updates are automatic or prompted by a particular action or event.

The feedback receiving engine 266 may include hardware, software and/or firmware configured to receive feedback regarding one or more classifications of elements and/or forms by the element classification engine 256 and/or the form classification engine 258, and/or of proposed or implemented actions by the action proposing engine 260 and the action implementing engine 262. Such feedback may indicate any erroneous classifications and/or erroneous or improper actions which resulted in an error indication or message. This feedback may be compiled and reformatted into a training dataset for subsequent training of the one or more machine learning components 212.

The feedback buffer storage 267 may include hardware, software and/or firmware configured to store the feedback from the feedback receiving engine 266, respective timestamps thereof, and/or one or more remedial measures to resolve any erroneous classifications and/or erroneous or improper actions, and whether such remedial measures were successful.

FIG. 2B illustrates an example implementation of the information extraction engine 252. The information extraction engine 252 may encompass a source code extraction engine 272, a source code buffer storage 273, a context extraction engine 274, a context buffer storage 275, a metadata extraction engine 276, and a metadata buffer storage 277. The source code extraction engine 272 may include hardware, software and/or firmware configured to extract or obtain source code of the form. The source code may indicate elements, types or classifications thereof, respective relative positions of the elements on the form, whether the elements are static or dynamic, and if dynamic, specific triggers, events, or inputs that cause the elements to populate or change. The source code may also indicate which elements are actually intended elements, rather than spurious or unintended elements from an external source (e.g., spam or malware). The source code extraction engine 272 may also obtain information of one or more previous or preceding forms, such as indications of elements, types or classifications thereof, respective relative positions of the elements on the previous forms, and whether the elements are static or dynamic. Meanwhile, the source code buffer storage 273 may include hardware, software and/or firmware configured to store the information obtained by the source code extraction engine 272, and respective timestamps at which the information was obtained.

The context extraction engine 274 may include hardware, software and/or firmware configured to extract or obtain visible information on the form, such as elements, text, and/or other features within the form, and relative positions thereof. The context extraction engine 274 may also obtain contextual information from one or more previous or preceding forms. The visible information from the context extraction engine 274 may corroborate and/or further augment the information from the source code extraction engine 272. The context buffer storage 275 may include hardware, software and/or firmware configured to store the information obtained by the context extraction engine 274, and respective timestamps at which the information was obtained.

The metadata extraction engine 276 may include hardware, software and/or firmware configured to extract metadata of the form, such as previous versions and/or historical information of the form, such as, a lineage or historical evolution of the form. For example, the element classification engine 256 and/or the form classification engine 258 may reference or retrieve one or more classifications of previous versions of a form in order to infer one or more classifications of a current version of the form. The metadata buffer storage 277 may include hardware, software and/or firmware configured to store the metadata of the form.

FIGS. 3-4, 5A, 5B, and 6-13 illustrate different example implementations of the processing servers 101, in particular, in performing inferences on a wide variety of element types and form types, especially on non-static or dynamically changing forms, thus illustrating a versatility of the present invention. FIG. 3 illustrates an example implementation of the processing servers 101, of performing inferences of elements and on an electronic form classified as a login form. In FIG. 3, a form 301 may include elements 302 and 304, and a button 306 to submit information within the elements 302 and 304. Selection or clicking on the button 306 may trigger populating of a subsequent form. First, the element classification engine 256 may infer that the element 302 is classified as an identification field 312, with a given probability 313, and that the element 304 is classified as a security field 314, with a given probability 315. This inference may be based on text associated with the elements, and/or relative positions of the elements. Although only one inferred identification and one given probability is illustrated in FIG. 3, the element classification engine 256 may output multiple inferences and probabilities for a single element. The element classification engine 256 may output or otherwise indicate such inferences within a representation 311 of the form 301. Next, the form classification engine 258 may infer that the form 301 is classified as a login form 316, with a given probability 317, based on the inferences from the element classification engine 256. Although only one inferred identification and one given probability is illustrated in FIG. 3, the form classification engine 258 may output multiple inferences and probabilities for a single form. The form classification engine 258 may output or otherwise indicate such inferences within a representation 321 of the form 301. The form classification engine 258 and/or the element classification engine 256 may substantiate, verify, confirm, or validate the inference of the login form 316, and/or the inferences 312 and 314. In particular, the form classification engine 258 may determine whether any of the inferences 312 and 314 are inconsistent with or reduce a likelihood of the form 301 being classified as a login form 316. If so, the form classification engine 258 and/or the element classification engine 256 may attempt to reconcile any inferences 312 and 314, and/or of the inference of the form 301 as a login form 316. For example, here, the form classification engine 258 may determine that an identification field and a security field are all consistent with a payment form. However, hypothetically, if the form 301 were to have more than a threshold number of identification fields, such as, greater than three identification fields, then the form classification engine 258 may determine that the presence of such a number of identification fields may reduce a probability of the form being classified as a login form. Thus, the form classification engine 258 may determine if other classifications are equally likely or possible, and/or the element classification engine 256 may attempt to infer whether any of the inferred identification fields may be reclassified as other field types.

Next, the action proposing engine 260 may populate icons and/or buttons to perform one or more actions, as described above with respect to the action proposing engine 260 in FIG. 1. These buttons may include an action button 332 and/or an error reporting button 333, and are represented in a representation 331 of the form 301. The actions may include, for example, autofilling or autocompleting any of the elements 302 and 304 by retrieving stored entries within the client device 162. Clicking or selecting the action button 332 may trigger an action such as autofilling or autocompleting, while clicking or selecting the error reporting button 333 may trigger documentation of an error such as a classification error or an erroneous action. This documentation of an error indication may be used to generate a training dataset to train the machine learning components 212. Action buttons and error reporting buttons described in subsequent FIGS. may be implemented in a same or similar manner as the action button 332 and the error reporting button 333, respectively.

FIG. 4 illustrates an example implementation of the processing servers 101 in performing inferences of elements and of an electronic form classified as a payment form. In FIG. 4, a form 401 may include elements 402 and 404 and a button 406 to submit information within the elements 402 and 404. Selection or clicking on the button 406 may trigger populating of a subsequent form. First, the element classification engine 256 may infer that the element 402 is classified as a payment identification field 412, with a given probability 413, and that the element 404 is classified as a payment validation field 414, with a given probability 415. This inference may be based on text associated with the elements, and/or relative positions of the elements. Although only one inferred identification and one given probability is illustrated in FIG. 4, the element classification engine 256 may output multiple inferences and probabilities for a single element. For example, the element classification engine 256 may have inferred that element 402 is classified as a credit card identification field, and/or a bank account identification field, with lower probabilities. The element classification engine 256 may output or otherwise indicate such inferences within a representation 411 of the form 401. Next, the form classification engine 258 may infer that the form 401 is classified as a payment form 416, with a given probability 417, based on the inferences from the element classification engine 256. Although only one inferred identification and one given probability is illustrated in FIG. 4, the form classification engine 258 may output multiple inferences and probabilities for a single form. The form classification engine 258 may output or otherwise indicate such inferences within a representation 421 of the form 401. The form classification engine 258 and/or the element classification engine 256 may substantiate, verify, confirm, or validate the inference of the payment form 416, and/or the inferences 412 and 414. In particular, the form classification engine 258 may determine whether any of the inferences 412 and 414 are inconsistent with or reduce a likelihood of the form 401 being classified as a payment form 416. If so, the form classification engine 258 and/or the element classification engine 256 may attempt to reconcile any inferences 412 and 414, and/or of the inference of the form 401 as a payment form 416. For example, here, the form classification engine 258 may determine that a payment identification field and a payment validation field are all consistent with a payment form.

Next, the action proposing engine 260 may populate icons and/or buttons to perform one or more actions, as described above with respect to the action proposing engine 260 in FIG. 1. These buttons may include an action button 432 and/or an error reporting button 433, and are represented in a representation 431 of the form 401. The actions may include, for example, autofilling or autocompleting any of the elements 402 and 404 by retrieving stored entries within the client device 162. Clicking or selecting the action button 432 may trigger an action such as autofilling or autocompleting, while clicking or selecting the error reporting button 433 may trigger documentation of an error such as a classification error or an erroneous action.

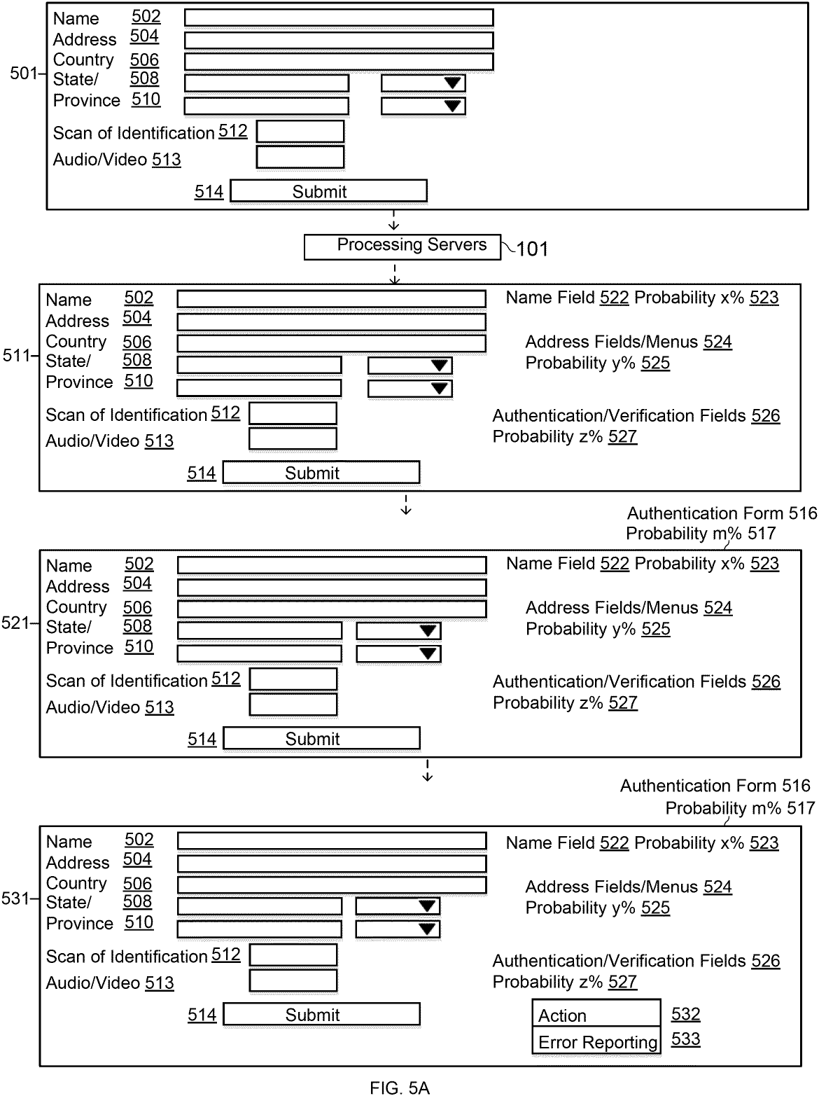

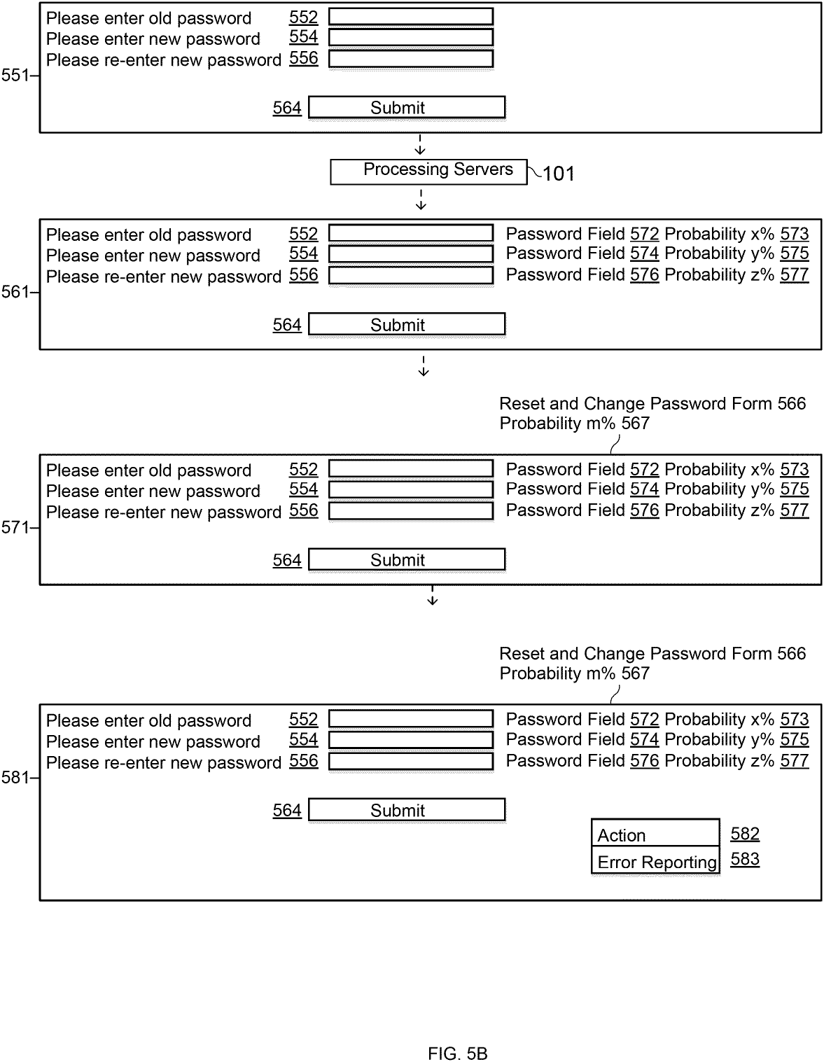

FIG. 5A illustrates an example implementation of the processing servers 101 in performing inferences of elements and of an electronic form classified as an authentication form. In FIG. 5A, a form 501 may include elements 502, 504, 506, 508, 510, 512, and/or 513, and a button 514 to submit information within the elements 502, 504, 506, 508, 510, 512, and/or 513. Selection or clicking on the button 514 may trigger populating of a subsequent form. First, the element classification engine 256 may infer that the element 502 is classified as a name field 522, with a given probability 523. The element classification engine 256 may infer that the elements 504, 506, 508, and 510 are collectively or individually classified as address fields or menus 524, with one or more given probabilities 525. Some of the elements may be fields, tabs, or menus (e.g., drop-down menus). The element classification engine 256 may infer that the elements 512 and 513 are collectively or individually classified as authentication or verification fields 526, with one or more given probabilities 527. These inferences may be based on text associated with the elements, and/or relative positions of the elements. Although only one inferred identification and one given probability is illustrated in FIG. 5A, the element classification engine 256 may output multiple inferences and probabilities for a single element. The element classification engine 256 may output or otherwise indicate such inferences within a representation 511 of the form 501. The element classification engine 256 may further detect specific formats and/or file types of inputs prompted or permitted for each of the elements. For example, in the element 512, the element classification engine 256 may determine or detect that a textual input is not permitted, but an image file (e.g., JPEG/PNG) is permitted. In the element 513, the element classification engine 256 may determine or detect that a textual input or an image file is not permitted, but an audio or video file (e.g., Moving Picture Experts Group (MPEG), such as MP3 or MP4) is permitted. Next, the form classification engine 258 may infer that the form 501 is classified as an authentication form 516, with a given probability 517, based on the inferences from the element classification engine 256. Although only one inferred identification and one given probability is illustrated in FIG. 5A, the form classification engine 258 may output multiple inferences and probabilities for a single form. The form classification engine 258 may output or otherwise indicate such inferences within a representation 521 of the form 501. The form classification engine 258 and/or the element classification engine 256 may substantiate, verify, confirm, or validate the inference of the authentication form 516, and/or the inferences 522, 524, and 526. In particular, the form classification engine 258 may determine whether any of the inferences 522, 524, and 526 are inconsistent with or reduce a likelihood of the form 501 being classified as an authentication form 516. If so, the form classification engine 258 and/or the element classification engine 256 may attempt to reconcile any inferences 522, 524, and 526, and/or of the inference of the form 501 as an authentication form 516. For example, here, the form classification engine 258 may determine that a name field, address fields or menus, and authentication or verification fields are all consistent with an authentication form.

Next, the action proposing engine 260 may populate icons and/or buttons to perform one or more actions, as described above with respect to the action proposing engine 260 in FIG. 1. These buttons may include an action button 532 and/or an error reporting button 533, and are represented in a representation 531 of the form 501. The actions may include, for example, autofilling, autocompleting, or autoselecting any of the elements 502, 504, 506, 508, 510, 512, and/or 513 by retrieving stored entries within the client device 162. Clicking or selecting the action button 532 may trigger an action such as autofilling or autocompleting, while clicking or selecting the error reporting button 533 may trigger documentation of an error such as a classification error or an erroneous action.

FIG. 5B illustrates an example implementation of the processing servers 101 in performing inferences of elements and of an electronic form classified as a reset and password change form. In FIG. 5B, a form 551 may include elements 552, 554, and/or 556, and a button 564 to submit information within the elements 552, 554, and/or 556. Selection or clicking on the button 564 may trigger populating of a subsequent form. First, the element classification engine 256 may infer that the elements 552, 554, and 556 are classified as password fields 572, 574, and 576, respectively, with respective given probabilities 573, 575, and 577. These inferences may be based on text (e.g., “old password,” “new password”) which may correspond to or match keywords associated with a reset and password change form. Although only one inferred identification and one given probability for each of the elements 552, 554, and 556 is illustrated in FIG. 5B, the element classification engine 256 may output multiple inferences and probabilities for a single element. The element classification engine 256 may output or otherwise indicate such inferences within a representation 561 of the form 551. The element classification engine 256 may further detect specific formats and/or file types of inputs prompted or permitted for each of the elements 552, 554, and/or 556. For example, in the elements 552, 554, and/or 556, the element classification engine 256 may determine or detect that a manual textual input, or a text file, are permitted, but an image file (e.g., JPEG/PNG) is prohibited. Next, the form classification engine 258 may infer that the form 551 is classified as a reset and change password form 566, with a given probability 567, based on the inferences from the element classification engine 256. Although only one inferred identification and one given probability is illustrated in FIG. 5B, the form classification engine 258 may output multiple inferences and probabilities for a single form. The form classification engine 258 may output or otherwise indicate such inferences within a representation 571 of the form 551. The form classification engine 258 and/or the element classification engine 256 may substantiate, verify, confirm, or validate the inference of the reset and change password form 566, and/or the inferences 572, 574, and 576 of password fields. In particular, the form classification engine 258 may determine whether any of the inferences 572, 574, and 576 of password fields are inconsistent with or reduce a likelihood of the form 551 being classified as a reset and change password form 566. If so, the form classification engine 258 and/or the element classification engine 256 may attempt to reconcile any inferences 572, 573, and 576, and/or of the inference of the form 551 as a reset and change password form 566. For example, here, the form classification engine 258 may determine that an existence of numerous password fields, rather than a single password field, does not preclude a possibility of a form being classified as a reset and change password form, and/or does not reduce a probability of a form being classified as a reset and change password form, compared to a form having only a single password field.

Next, the action proposing engine 260 may populate icons and/or buttons to perform one or more actions, as described above with respect to the action proposing engine 260 in FIG. 1. These buttons may include an action button 582 and/or an error reporting button 583, and are represented in a representation 581 of the form 551. The actions may include, for example, autofilling, or autocompleting, any of the elements 552, 554, and 556 by retrieving stored entries within the client device 162. Clicking or selecting the action button 582 may trigger an action such as autofilling or autocompleting, while clicking or selecting the error reporting button 583 may trigger documentation of an error such as a classification error or an erroneous action.

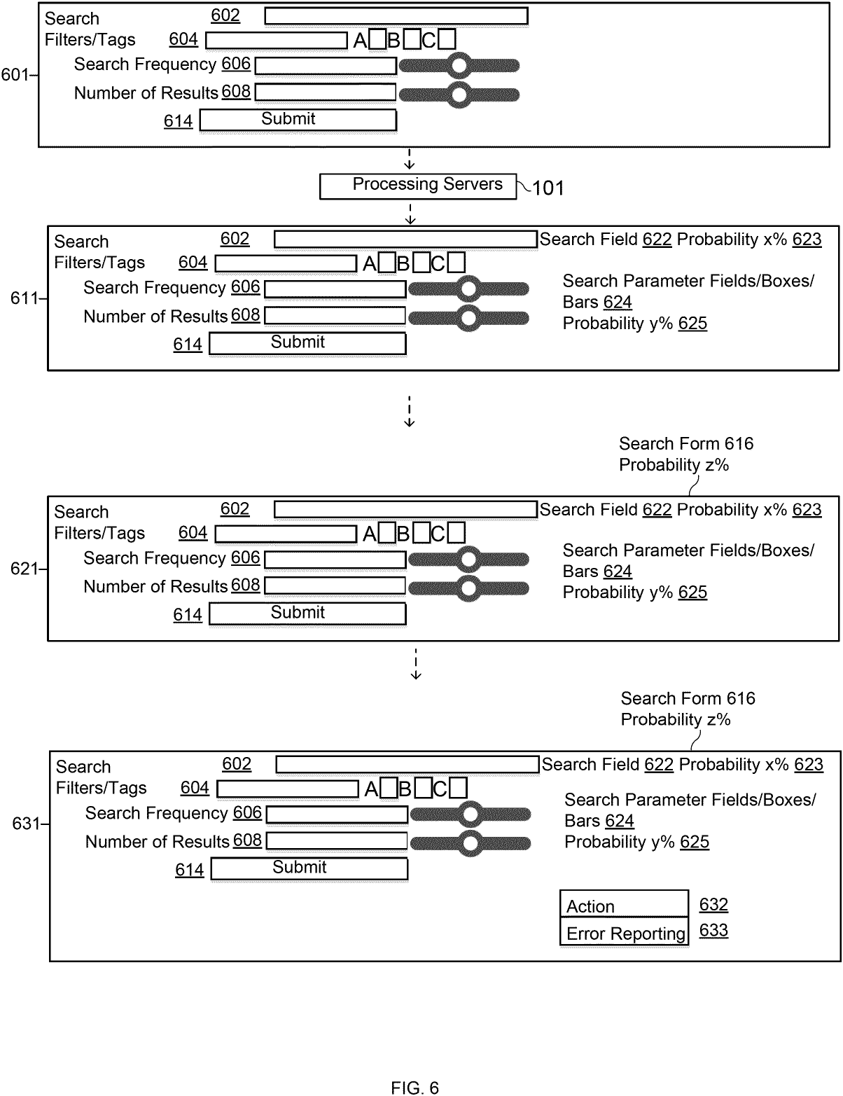

FIG. 6 illustrates an example implementation of the processing servers 101 in performing inferences of elements and of an electronic form classified as a search form. In FIG. 6, a form 601 may include elements 602, 604, 606, and/or 608, and a button 614 to submit information within the elements 602, 604, 606, and/or 608. Selection or clicking on the button 614 may trigger populating of a subsequent form. First, the element classification engine 256 may infer that the element 602 is classified as a search field 622, with a given probability 623. The element classification engine 256 may infer that the elements 604, 606, and/or 608 are collectively or individually classified as search parameter fields, boxes, or bars 624 with one or more given probabilities 625. Some of the elements may be fields, boxes, tabs, menus or bars (e.g., toggle bars, selection boxes). These inferences may be based on text associated with the elements, and/or relative positions of the elements. Although only one inferred identification and one given probability is illustrated in FIG. 6, the element classification engine 256 may output multiple inferences and probabilities for a single element. The element classification engine 256 may output or otherwise indicate such inferences within a representation 611 of the form 601. Next, the form classification engine 258 may infer that the form 601 is classified as an search form 616, with a given probability 617, based on the inferences from the element classification engine 256. Although only one inferred identification and one given probability is illustrated in FIG. 6, the form classification engine 258 may output multiple inferences and probabilities for a single form. The form classification engine 258 may output or otherwise indicate such inferences within a representation 621 of the form 601. The form classification engine 258 and/or the element classification engine 256 may substantiate, verify, confirm, or validate the inference of the search form 616, and/or the inferences 622 and 624 of a search field 622, and/or of search parameter fields, boxes, or bars 624. In particular, the form classification engine 258 may determine whether any of the inferences 622 and 624 are inconsistent with or reduce a likelihood of the form 601 being classified as a search form 616. If so, the form classification engine 258 and/or the element classification engine 256 may attempt to reconcile any inferences 622 and 624, and/or of the inference of the form 601 as a search form 616. For example, here, the form classification engine 258 may determine that an existence of a search field in conjunction with search parameter field, boxes, or bars, rather than a single search field, does not reduce a probability of a form being classified as a search form, compared to a form having only a single search field.

Next, the action proposing engine 260 may populate icons and/or buttons to perform one or more actions, as described above with respect to the action proposing engine 260 in FIG. 1. These buttons may include an action button 632 and/or an error reporting button 633, and are represented in a representation 631 of the form 601. The actions may include, for example, autofilling, autocompleting, or autoselecting any of the elements 602, 604, 606, and/or 608 by retrieving stored entries within the client device 162. Clicking or selecting the action button 632 may trigger an action such as autofilling or autocompleting, while clicking or selecting the error reporting button 633 may trigger documentation of an error such as a classification error or an erroneous action.

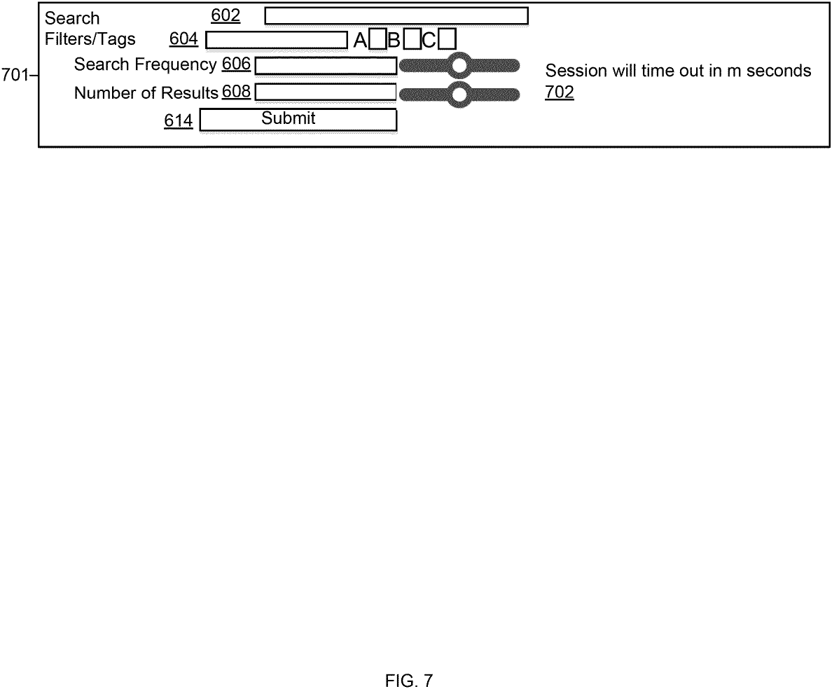

FIG. 7 illustrates an example implementation of the processing servers 101 of suggesting and/or performing a downstream action to avoid a time-out of an electronic form. In FIG. 7, a form 701 may include the elements 602, 604, 606, and/or 608, and the button 614 to submit information within the elements 602, 604, 606, and/or 608. The form 701 may be an updated version or representation of the form 601 in FIG. 6, with an additional indication that the form 701 will time out after a given interval of time, as compared with the form 601, upon which the form 701 may revert to a previous or preceding form (e.g., a login form). In some examples, the element classification engine 256 may recognize or infer a time-out feature, and may transmit this indication to the action proposing engine 260. The action proposing engine 260 may, in turn, suggest to perform one or more actions, such as clicking within the form 701, to prevent time-out.

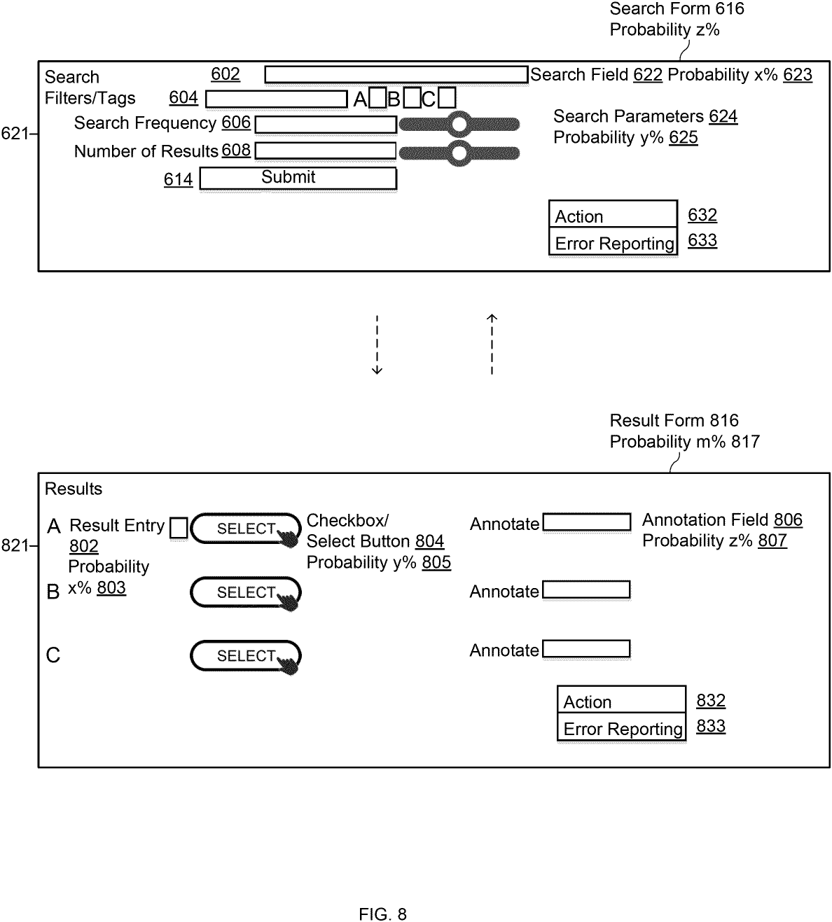

FIG. 8 illustrates an example implementation of the processing servers 101, in particular, in detecting updates to an electronic form, in which the electronic form switches between different versions or representations. In FIG. 8, a form may switch between the representation 621 and a representation 821. For example, the form may automatically switch, at given intervals, between the representations 621 and 821, such as, switching every minute between the representations 621 and 821, as detected by the update receiving engine 264. In other words, in one minute, the representation 621 may be populated on the client device 162, and in the next minute, the representation 821 may be populated on the client device 162. The element classification engine 256 may infer that the representation 821 includes one or more result entries 802 with given probabilities 803, and checkboxes or select buttons 804 with given probabilities 805, and annotation fields 806 with given probabilities 807. In particular, the checkboxes or select buttons 804 may trigger selection of any of the results for further review or action, and the annotation fields 806 may trigger manual and/or automatic annotations of any of the results. The representation 821 may be inferred by the form classification engine 258 as a result form 816 with a given probability 817. Additionally, the representation 821 may include an action button 832 and an error reporting button 833, which may be implemented in a same or similar manner as the action buttons 732, 632, 532, 432, and 332, and the error reporting buttons 733, 633, 533, 433, and 333, respectively. For example, clicking on or selecting the action button 832 may trigger or cause performing of one or more actions such as automatically checking or selecting results that satisfy certain criteria, and/or annotating such results.

Upon detecting, by the update receiving engine 264, that the form changes between the representations 621 and 821, the update receiving engine 264 may trigger saving of the inferences or proposed actions, from the element classification engine 256, the form classification engine 258, and the action proposing engine 260, for the representations 621 and 821, so that the inferences or proposed actions do not need to be reperformed by the respective engines. Thus, at any point which the form changes representations, the inferences and/or proposed actions are readily available, thereby conserving time and computing resources.

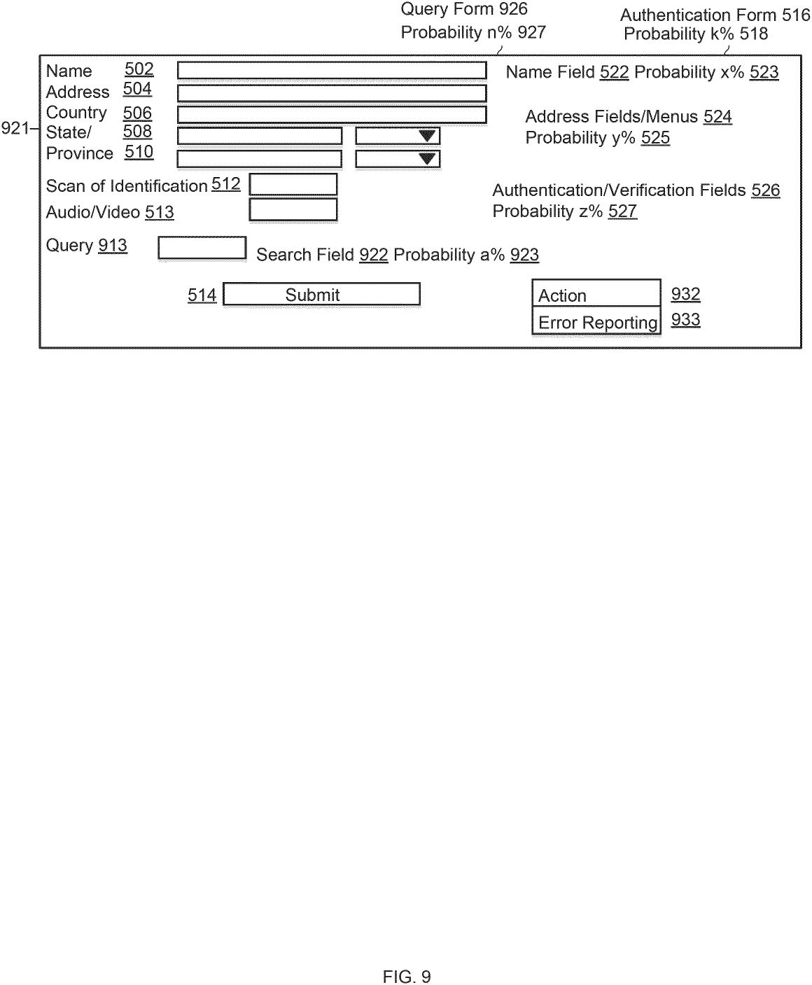

FIG. 9 illustrates an example implementation of the processing servers 101, in particular, in detecting updates within a form, in which an action causes or results in populating of new elements. In other examples, such an action may, in addition to causing or resulting in new elements being populated, render a previously invisible element or form visible, or cause or result in modification of an existing element, such as, changes in an element type or information prompted within an element (e.g., requesting an image of an identification such as a driver’s license rather than textually inputted information from the identification). In FIG. 9, a representation 921 of a form may populate an additional element in response to an action, such as an approval by a different entity such as an external processor or a person. The representation 921 may include the elements previously described in FIG. 5A and an additional element in response to an action. In particular, after a user of the client device 162 inputs an image within the element 512, and/or an audio or video within the element 513, an external processor and/or a person may approve or authenticate the input. Only after such approval or authentication, an element 913 may be populated, for example, which permits the user to perform an additional action. The update receiving engine 264 may detect the element 913 as being additionally populated, and/or recognize that a particular action is required for the element 913 to be additionally populated and monitor for that particular action (e.g., by accessing a relevant or corresponding dataset or data source) to detect if or when it has been performed. Subsequently, the element classification engine 256 may infer a classification of the element 913 as a search field 922, with a given probability 923. The form classification engine 258 may then infer a classification of the form based on the update of the element 913 being additionally populated. For example, the form classification engine 258 may infer that the representation 921 of the form is classified as an authentication form 516 with an updated probability 518, and also that the representation 921 is classified as a query form 926 with a given probability 927. In some examples, a single form may be appropriately classified as two different types. Next, the action proposing engine 260 may update proposed or suggested actions, such as, autocompleting or autofilling the element 913 which previously was absent in FIG. 5A. The action proposing engine 260 may populate icons and/or buttons to perform one or more actions, including an action button 932 and an error reporting button 933.

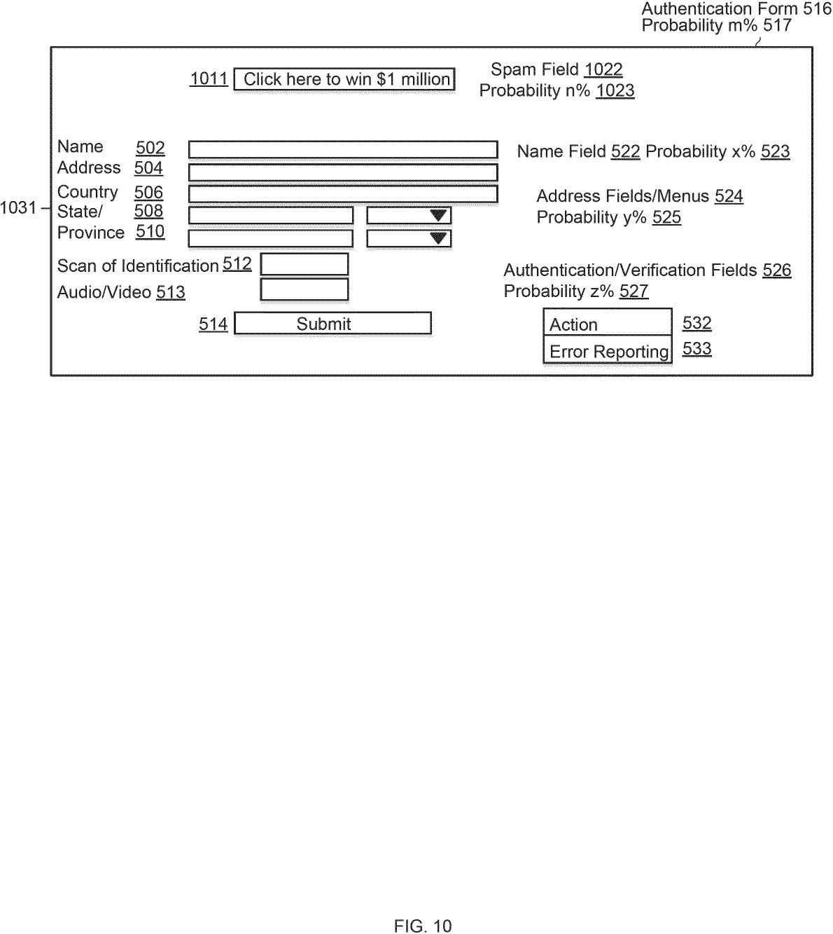

FIG. 10 illustrates an example implementation of the processing servers 101, in particular, in avoiding erroneous detection due to spurious or unintended elements. In FIG. 10, a representation 1031 of a form may include the elements previously described in FIG. 5A, in addition to a spurious or unintended element 1011 that may have been populated or displayed at some point in time. The update receiving engine 264 may have detected the spurious or unintended element 1011, and the element classification engine 256 may have recognized the spurious or unintended element 1011, for example, because it is absent from the underlying coding of the form, and that the spurious or unintended element 1011 deviates from, or shares no mapping or has a minimal relationship (e.g., below a threshold degree of mapping or proximity of relationship) with the previous inferred classification of the form as an authentication form 516. Therefore, the form classification engine 258 does not account for the spurious or unintended element 1011 in inferring a classification of the form to avoid erroneous classification.

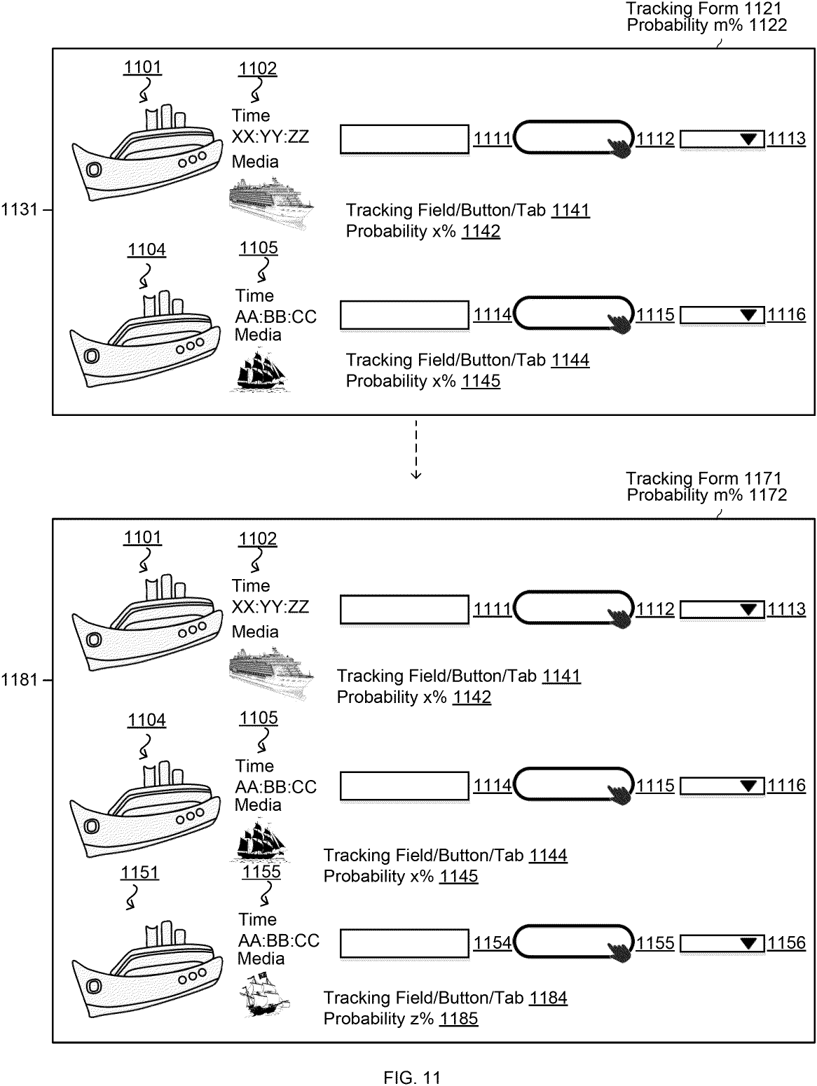

FIG. 11 illustrates an example implementation of the processing servers 101, in particular, in detecting updates within a form, in which updates of entities being tracked within the electronic form cause or result in populating of new elements. In FIG. 11, a representation 1131 of a form may include entities 1101 and 1104 and attributes 1102 and 1105, respectively, as the entities 1101 and 1104 are tracked. For example, once an entity such as a ship is within a given location or region, that entity may be tracked, and one or more elements may be populated. The elements include 1111, 1112, and/or 1113 corresponding to the entity 1101, and 1114, 1115, and/or 1116 corresponding to the entity 1104. The element classification engine 256 infers the elements 1111 , 1112, and/or 1113 as tracking fields, buttons, or tabs 1141, with one or more given probabilities 1141, and infers the elements 1114, 1115, and/or 1116 as tracking fields, buttons, or tabs 1144, with one or more given probabilities 1145. The form classification engine 258 infers a classification of the form as a tracking form 1121, with a given probability 1122.

The representation 1131 may be updated to an updated representation 1181 as an additional entity 1151 is populated, with attributes 1155, which causes additional elements 1154, 1155, and/or 1156 to be populated. The update receiving engine 264 may detect or determine the additional elements 1154, 1155, and/or 1156 and/or recognize that a particular event (e.g., an entity being within a given location or region) is required for the additional elements 1154, 1155, and/or 1156 to be populated and monitor for that particular event (e.g., by accessing a relevant or corresponding dataset) to detect if or when it has occurred. Subsequently, the element classification engine 256 may infer the additional elements 1154, 1155, and/or 1156 as being classified as tracking fields, buttons, or tabs 1184, with one or more given probabilities 1185. The form classification engine 258 may then infer a classification of the form based on the update of the additional elements 1154, 1155, and/or 1156 being populated. For example, the form classification engine 258 may infer that the classification of the form is unchanged between the representation 1131 and the updated representation 1181. In other examples, an update or change in an entity (e.g., with respect to a particular geospatial location or region) may, in addition to causing or resulting in new elements being populated, render a previously invisible element or form visible, or cause or result in modification of an existing element, such as, changes in an element type or information prompted within an element (e.g., requesting an image of an identification such as a driver’s license rather than textually inputted information from the identification).

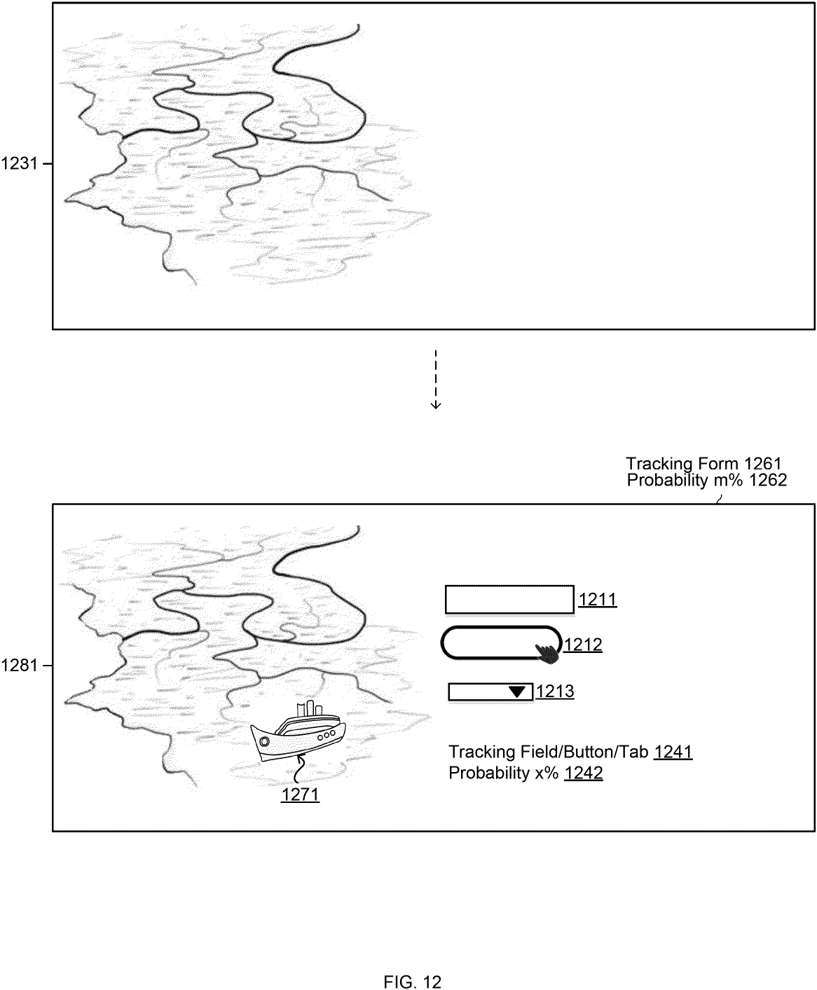

FIG. 12 illustrates an example implementation of the processing servers 101, in particular, in detecting updates within a form, in which new entities being tracked within the electronic form cause or result in populating of new elements. In FIG. 12, a representation 1231 of a form may not include any detectable elements conducive to classification, and thus, a classification of the representation 1231 may be unknown. The representation 1231 may be updated to an updated representation 1281, which includes an entity 1271. For example, the updated representation 1281 may track one or more entities, such as movement of one or more entities. In response to the entity 1271 appearing, for example, within a given region or location, elements 1211, 1212, and/or 1213 may be populated. The update receiving engine 264 may detect or determine the elements 1211, 1212, and/or 1213 and/or recognize that a particular event (e.g., an entity being within a given location or region) is required for the elements 1211, 1212, and/or 1213 to be populated and monitor for that particular event (e.g., by accessing a relevant or corresponding dataset) to detect if or when it has occurred. Subsequently, the element classification engine 256 may infer the elements 1211, 1212, and/or 1213 as being classified as tracking fields, buttons, or tabs 1241, with one or more given probabilities 1242. The form classification engine 258 may then infer a classification of the form based on the elements 1211, 1212, and/or 1213 being populated, and/or other features such as images on the updated representation 1281. For example, the form classification engine 258 may infer that the classification of the form is a tracking form 1261 with a given probability 1262. In other examples, a new entity may, in addition to causing or resulting in new elements being populated, render a previously invisible element or form visible, or cause or result in modification of an existing element, such as, changes in an element type or information prompted within an element (e.g., requesting an image of an identification such as a driver’s license rather than textually inputted information from the identification).

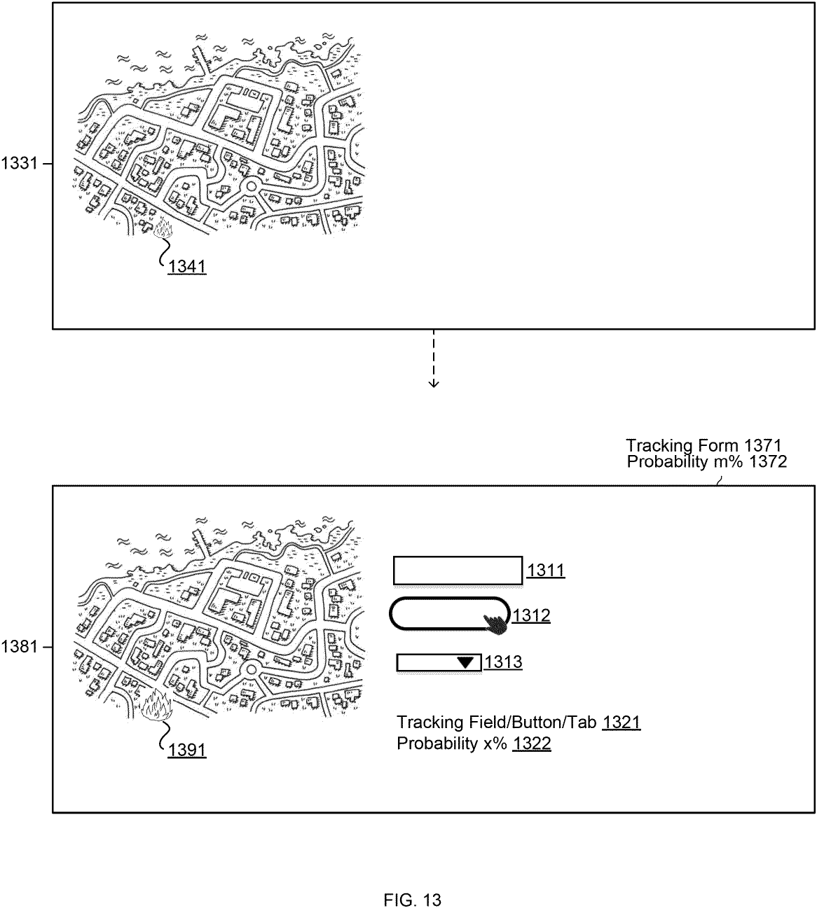

FIG. 13 illustrates an example implementation of the processing servers 101, in particular, in detecting updates within a form, in which changes to entities being tracked within the electronic form cause or result in populating of new elements. In FIG. 13, a representation 1331 of a form may include an entity 1341, but may not include any detectable elements for classification, and thus, a classification of the representation 1331 may be unknown. The representation 1331 may be updated to an updated representation 1381, which includes an updated entity 1391. For example, the updated representation 1381 may have been updated in that the entity 1341 has been enlarged or otherwise changed certain parameters. For example, the updated representation 1381 may be used to track one or more parameters or characteristics of one or more entities, such as a fire, once certain attributes or parameters satisfy certain criteria. In response to the updated entity 1391 satisfying some criteria, elements 1311, 1312, and/or 1313 may be populated. The update receiving engine 264 may detect or determine the elements 1311, 1312, and/or 1313 and/or recognize that a particular criteria (e.g., an entity satisfying a certain size) is required for the elements 1311, 1312, and/or 1313 to be populated and monitor for that particular criteria (e.g., by accessing a relevant or corresponding dataset) to detect if or when it has been satisfied. Subsequently, the element classification engine 256 may infer the elements 1311, 1312, and/or 1313 as being classified as tracking fields, buttons, or tabs 1321, with one or more given probabilities 1322. The form classification engine 258 may then infer a classification of the form based on the elements 1311, 1312, and/or 1313 being populated, and/or other features such as images on the updated representation 1381. For example, the form classification engine 258 may infer that the classification of the form is a tracking form 1371 with a given probability 1372. In other examples, a change in an attribute or property of an entity (e.g., a size) may, in addition to causing or resulting in new elements being populated, render a previously invisible element or form visible, or cause or result in modification of an existing element, such as, changes in an element type or information prompted within an element (e.g., requesting an image of an identification such as a driver’s license rather than textually inputted information from the identification).

FIG. 14 illustrates an example implementation of training of the machine learning components 212. In particular, a training system 1401 may include a training engine 1406, a training buffer storage 1408, a feedback engine 1410, and a feedback buffer storage 1412. In some examples, the training system 1401 may be implemented as part of the controller 250 in FIG. 2A. The training engine 1406 may include hardware, software and/or firmware configured to use the communications interface and APIs 251 to train the machine learning components 212. The training of the machine learning components 212 may encompass generating a first training dataset that includes previous examples or scenarios of inferred or verified elements and electronic forms. Information from the first training dataset may be curated and/or normalized. For example, terminology, syntax, symbols, and/or accent marks may be normalized, in a same or similar process as described with respect to the normalization engine 254 in FIG. 2A. The training buffer storage 1408 may include hardware, software and/or firmware configured to store the first training dataset, the normalized first training dataset, and/or any results from the training using the normalized first training dataset.

Following the training using the normalized first training dataset, the machine learning components 212 may perform inferences of the classifications of elements and forms, and probabilities thereof. The feedback engine 1410 may include hardware, software and/or firmware configured to use the communications interface and APIs 251 to perform subsequent training of the machine learning components 212 using feedback, for example, from the feedback receiving engine 266. A second training dataset may be generated, which includes erroneous inferences of element and/or form classifications, and/or erroneous proposed actions as obtained by the feedback receiving engine 266, and/or any remedial actions to rectify the erroneous inferences and/or actions. The second training dataset may be curated and normalized. The feedback buffer storage 1412 may include hardware, software and/or firmware configured to store the second training dataset, the normalized second training dataset, and/or any results from the training using the normalized second training dataset, such as, a resulting accuracy following the training and/or whether the resulting accuracy following the training improved.

FIG. 15 illustrates an example implementation of training of the machine learning components 212. As described previously, for example, with respect to FIG. 14, the machine learning components 212 may be initially trained using a first training dataset 1510, and subsequently trained using a second training dataset 1520. The second training dataset 1520 may include scenarios or examples 1502 and respective timestamps 1512 of incorrectly inferred element classifications or form classifications by the element classification engine 256 or the form classification engine 258, and/or any remedial measures to rectify the incorrect inferences. The second training dataset 1520 may, additionally or alternatively, include scenarios or examples 1504 and respective timestamps 1514 of incorrectly proposed actions by the action proposing engine 260. For example, if the action proposing engine 260 proposed to fill in a credit card number in a field that prompts for a bank account number, such an error may indicate an improper classification of a form or field, or an incorrect mapping between a particular field classification and an action.

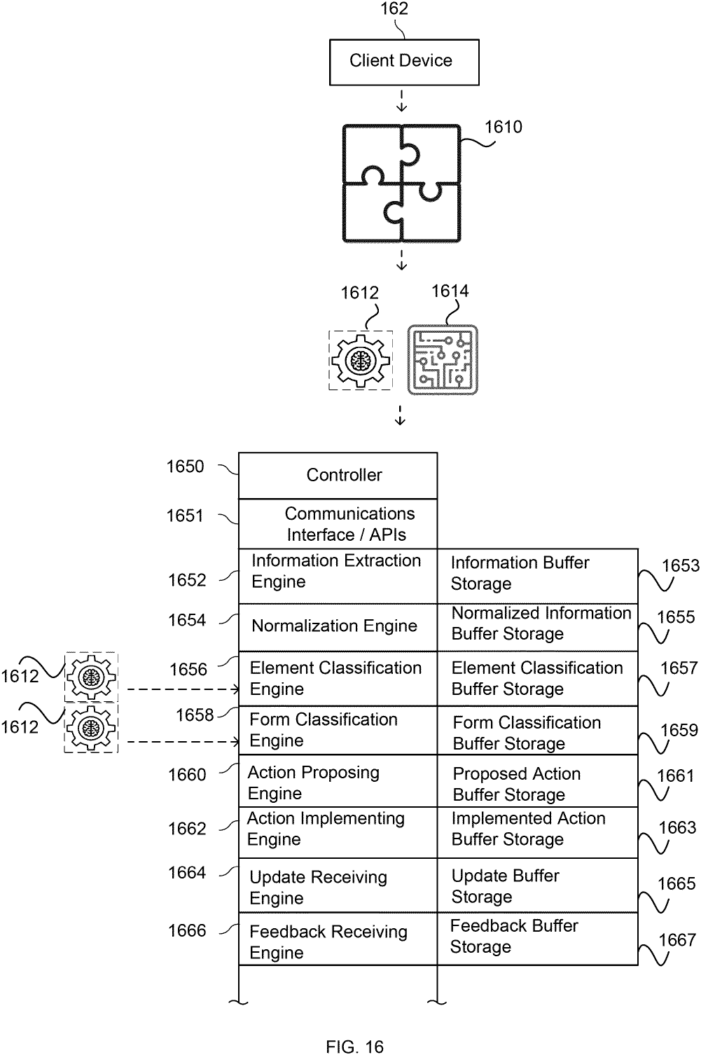

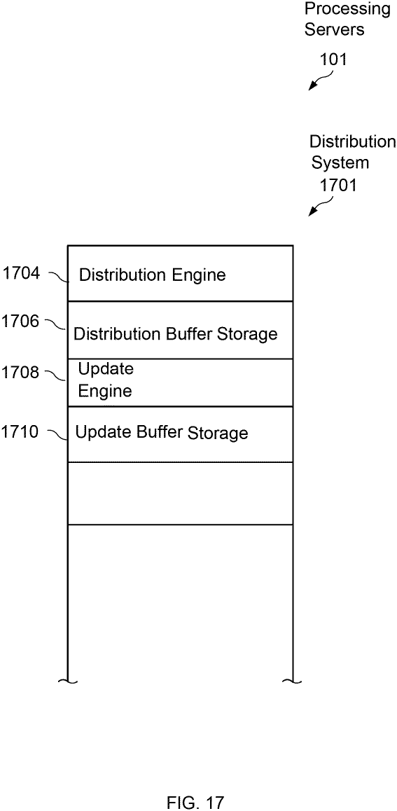

In the previous FIGS. 2A, 2B, 3-4, 5A, 5B, and 6-13, the processes of inference of elements and forms, and implementation of downstream actions, have been implemented by the processing servers 101 which are external to the client device 162. However, in an alternative implementation, as illustrated in FIGS. 16 and 17, the processes of inference may be performed directly at the client device 162. In particular, the processing servers 101 may distribute or transmit a plugin 1610, which may include a package (e.g., a JavaScript package) encompassing one or more machine learning components 1612 and processors 1614. The machine learning components 1612 may be same as the machine learning components 212, or may be condensed versions of the machine learning components 212 which consume less storage space and/or consume less processing power. Thus, the processing servers 101 may distribute scaled down versions of the machine learning components 1612. An extent to which the machine learning components 1612 are scaled down may depend on the storage space and/or processing limitations or constraints of the client device 162. The machine learning components 1612 may be trained using the first training dataset 1510 and the second training dataset 1520, or a portion thereof. In some examples, the machine learning components 212 may be used to train the machine learning components 1612 which are scaled down compared to the machine learning components 212. Meanwhile, the processors 1614 may be identical to, similar to, or scaled down from the processors 214. In FIG. 16, the plugin 1610 may include a controller 1650, a communications interface and APIs 1651, an information extraction engine 1652, a normalization engine 1654, an element classification engine 1656, a form classification engine 1658, an action proposing engine 1660, an action implementing engine 1662, an update receiving engine 1664, and a feedback receiving engine 1666, and/or information buffer storage 1653, normalized information buffer storage 1655, element classification buffer storage 1657, form classification buffer storage 1659, proposed action buffer storage 1661, implemented action buffer storage 1663, update buffer storage 1665, and feedback buffer storage 1667. These may be implemented in an analogous manner as the controller 250, the communications interface and APIs 251, the information extraction engine 252, the normalization engine 254, the element classification engine 256, the form classification engine 258, the action proposing engine 260, the action implementing engine 262, the update receiving engine 264, and the feedback receiving engine 266, and/or the information buffer storage 253, the normalized information buffer storage 255, the element classification buffer storage 257, the form classification buffer storage 259, the proposed action buffer storage 261, the implemented action buffer storage 263, the update buffer storage 265, and the feedback buffer storage 267, as described in FIG. 2A. Additionally, any of the implementations illustrated in FIGS. 3-4, 5A, 5B, and 6-13 may also be applicable to FIG. 16.

FIG. 17 illustrates an implementation of the processing servers 101 in performing distribution of machine learning components and/or processing components to the client device 162 and other client devices. In particular, the processing servers 101 may include a distribution system 1701 which may be implemented as part of the controllers 250 in FIG. 2A. The distribution system may include a distribution engine 1704, a distribution buffer storage 1706, an update engine 1708, and an update buffer storage 1710. The distribution engine 1704 may include hardware, software and/or firmware configured to distribute or transmit a plugin (e.g., a JavaScript package), which may include one or more machine learning components and/or processors. The distribution buffer storage 1706 may include hardware, software and/or firmware configured to store information of distributions of updates, including logs and/or timestamps.

The update engine 1708 may include hardware, software and/or firmware configured to use the communications interface and APIs 251 to update the machine learning components 1612 and/or the processors 1614. For example, the updates to the machine learning components 1612 may be based on information received from the feedback receiving engine 266 and/or subsequent training datasets that indicate erroneous inferences and/or actions made by the element classification engine 256 or 1656, the form classification engine 258 or 1658, or the action proposing engine 260 or 1660. Thus, the updates to the machine learning components 1612 may be a result of subsequent retraining of the machine learning components 1612. The updates to the machine learning components 1612 may be periodic (e.g., after a given interval of time) or may be triggered by feedback from the feedback receiving engine 266 or 1666 of an erroneous inference or action, and/or of a threshold number or extent of erroneous inferences or actions. In some examples, the updating engine 1708 may receive an indication of a change in storage and/or processing attributes or constraints of the client device 162 or of other client devices, and may update or retrieve one or more different machine learning components and/or processors that satisfy the changed storage and/or processing attributes or constraints of the client device 162. For example, the client device 162 may have decreased its storage capacity, and thus, the updating engine 1708 may generate an updated plugin having a more scaled down version of the machine learning components 1612 and/or processors 1614. The update buffer storage 1710 may include hardware, software and/or firmware configured to store information of any updates, including logs and/or timestamps.

Following an update, the distribution engine 1704 may redistribute or retransmit an updated plugin, which may include one or more updated machine learning components and/or processors from the update engine 1708. The distribution buffer storage 1706 may store information of distributions of updates, including logs and/or timestamps.

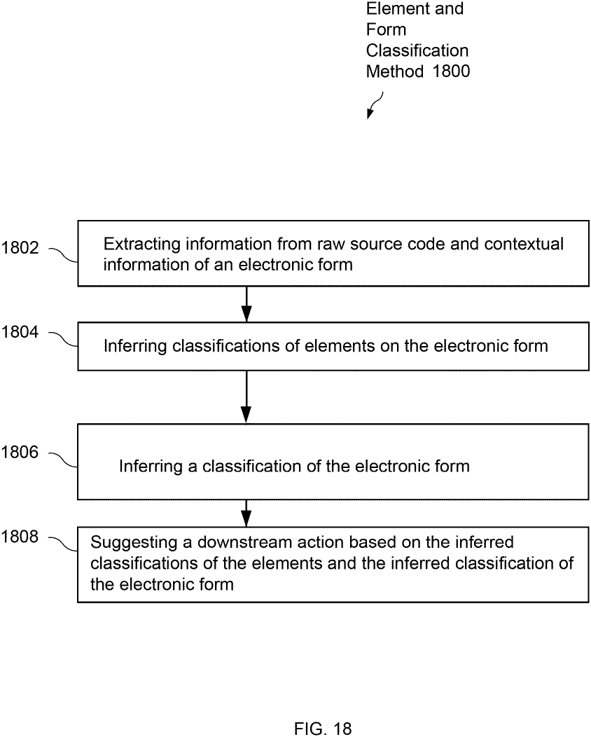

FIG. 18 is a flowchart of an element and form classification method 1800 of inferring one or more classifications of elements on a form, and of the form, in accordance with some embodiments of the present invention, and consistent with FIGS. 2A, 2B, 3-4, 5A, 5B, and 6–13. The element and form classification method 1800 begins in step 1802 with the information extraction engine 252 performing extracting of information from raw source code and contextual information of an electronic form. The raw source code may include invisible features while the contextual information may include visible features, such as element types and respective relative positions on a form, and on one or more preceding forms. The information may further include metadata, such as version and/or lineage information of a form, which may encompass previous versions of the form and any changes with respect to the previous versions. Here, elements may include any of fields, boxes, buttons, menus, lists and tabs, and more specifically, text fields, checkboxes, radio buttons, submit buttons, other clickable buttons, toggle switches, pull-down tabs, drop down menus and lists, as nonlimiting examples.

In step 1804, the processing servers 101, in particular, the element classification engine 256, may utilize the one or more machine learning components 212 to infer classifications of elements on the electronic form, as illustrated, for example, in FIGS. 3-4, 5A, 5B, and 6-13 and described with respect to FIG. 2A. The inferred classifications may be based on the information from the raw source code, the contextual information, and/or the metadata. In some examples, the inferring of the classifications may entail a sequential process that utilizes different machine learning components 212. For example, a first inference stage may include using one or more specific machine learning components tailored to one or more specific element classification types (e.g., a credit card or payment card machine learning component). The first inference stage may be based on both raw source code and contextual information, or both visible and invisible information. A second inference stage may include using one or more different machine learning components for element classification (e.g., field classification). During the second inference stage, the inferences may be initially based on only the visible information. However, if no inference has at least a threshold probability or confidence level, then the inferences may be reperformed based on both the visible and invisible information. In other examples, the first inference stage may be skipped or excluded. The element classification engine 256 may provide one or more inferences for a single element. The element classification engine 256 may further determine one or more probabilities of the respective inferences.

In step 1806, the processing servers 101, in particular, the form classification engine 258, may infer a classification of the electronic form based on the classifications of the elements on the electronic form, as illustrated, for example, in FIGS. 3-4, 5A, 5B, and 6-13 and described with respect to FIG. 2A.

In step 1808, the processing servers 101, in particular, the action proposing engine 260, may suggest or propose a downstream action based on the inferred classifications of the elements and the inferred classification of the electronic form. Such an action may include autocompleting, autofilling, or performing some action on an element, storing or recording information locally within the client device 162, transmitting information, triggering a flag or alert, or initiating an electronic or physical process. The suggested downstream action may be selectively performed, for example, in response to a user confirmation or approval. However, if the user indicates to perform a different action, then the different action may be performed, and such indication may be fed back to the training system 1401.

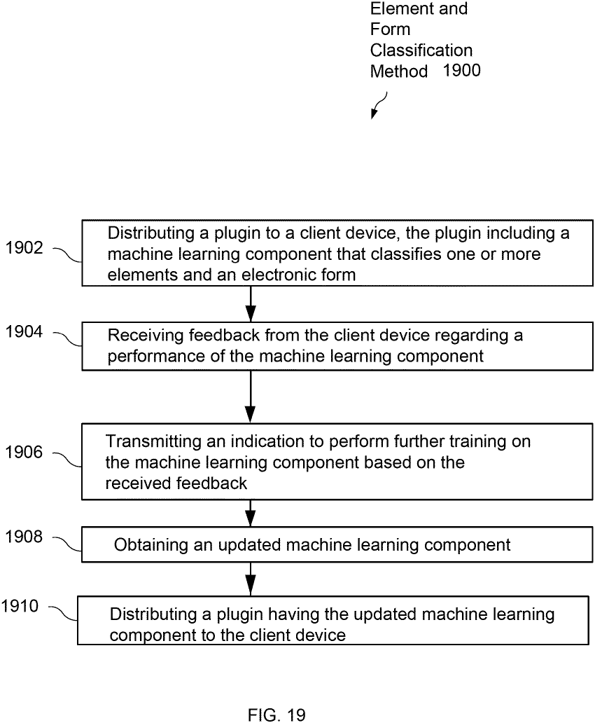

FIG. 19 is a flowchart of an element and form classification method 1900 of distributing a plugin, such that the process of inference may be carried out locally at the client device 162, consistent with FIGS. 16-17. In particular, the element and form classification method 1900 begins in step 1902 with the distribution engine 1704 distributing or transmitting, to one or more client devices such as the client device 162, a plugin. The plugin may include a package (e.g., a JavaScript package) including a machine learning component that classifies one or more elements within an electronic form, and classifies the electronic form as a whole. The machine learning component may be same as the machine learning component 212 that was trained at the processing servers 101, or a condensed version of the machine learning component 212, depending on storage and/or processing attributes or constraints of the client device 162.

At step 1904, the processing servers 101, in particular, the feedback receiving engine 266, may receive feedback from the client device 162 (e.g., from the feedback receiving engine 1766), and/or other client devices, regarding a performance of the machine learning component. For example, the feedback may encompass erroneous inferences and/or proposed actions.

At step 1906, the processing servers 101, in particular, the update engine 1708, may transmit an indication to perform further training on the machine learning component based on the received feedback. At step 1908, the processing servers 101, in particular, the update engine 1708, may update the machine learning component based on the received feedback. At step 1910, the processing servers 101, in particular, the distribution engine 1704, may distribute a plugin having an updated machine learning component to the client device 162.

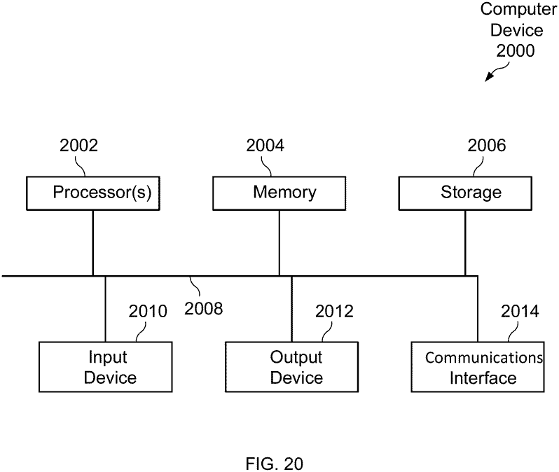

FIG. 20 is a block diagram of a computing device 2000, in accordance with some embodiments. In some embodiments, the computing device 2000 may be a particular implementation of the client device 162 and/or of the one or more of the processing servers 101, and may perform some or all of the functionality described herein. The computing device 2000 comprises one or more hardware processor 2002, memory 2004, storage 2006, an input device 2010, and output device 2012 and/or a communications interface 2014, all communicatively coupled to a communication channel 2008.

The one or more hardware processors 2002 may be configured to execute executable instructions (e.g., software programs, applications,). In some example embodiments, the one or more hardware processors 2002 comprises circuitry or any processor capable of processing the executable instructions.

The memory 2004 stores working data. The memory 2004 any include devices, such as RAM, ROM, RAM cache, virtual memory, etc. In some embodiments, the data within the memory 2004 may be cleared or ultimately transferred to the storage 2006 for more persistent retention. The term “memory” herein is intended to cover all data storage media whether permanent or temporary.

The storage 2006 includes any persistent storage device. The storage 2006 may include flash drives, hard drives, optical drives, cloud storage, magnetic tape and/or extensible storage devices (e.g., SD cards). Each of the memory 2004 and the storage 2006 may comprise a computer-readable medium, which stores instructions or programs executable by one or more hardware processors 2002.

The input device 2010 may include any device capable of receiving input information (e.g., a mouse, keyboard, microphone, etc.). The output device 2012 includes any device capable of outputting information (e.g., speakers, screen, etc.).

The communications interface 2014 may include any device capable of interfacing with external devices and/or data sources. The communications interface 2014 may include an Ethernet connection, a serial connection, a parallel connection, and/or an ATA connection. The communications interface 2014 may include wireless communication (e.g., 802.11, WiMax, LTE, 5G, WiFi) and/or a cellular connection. The communications interface 2014 may support wired and wireless standards.

A computing device 2000 may comprise more or less hardware, software and/or firmware components than those depicted (e.g., drivers, operating systems, touch screens, biometric analyzers, battery, APIs, global positioning systems (GPS) devices, various sensors and/or the like). Hardware elements may share functionality and still be within various embodiments described herein. In one example, the one or more hardware processors 2002 may include a graphics processor and/or other processors.

An “engine,” “system,” “datastore,” and/or “database” may comprise hardware, software, firmware, and/or circuitry. In one example, one or more software programs comprising instructions capable of being executable by a hardware processor may perform one or more of the functions of the engines, datastores, databases, or systems described herein. Circuitry may perform the same or similar functions. The functionality of the various systems, engines, datastores, and/or databases may be combined or divided differently. Memory or storage may include cloud storage. The term “or” may be construed as inclusive or exclusive. Plural instances described herein may be replaced with singular instances. Memory or storage may include any suitable structure (e.g., an active database, a relational database, a self-referential database, a table, a matrix, an array, a flat file, a documented-oriented storage system, a non-relational No-SQL system, and the like), and may be cloud-based or otherwise.

At least some of the operations of a method may be performed by the one or more hardware processors. The one or more hardware processors may operate partially or totally in a “cloud computing” environment or as a “software as a service” (SaaS). For example, some or all of the operations may be performed by a group of computers being accessible via a network (e.g., the Internet) and via one or more appropriate interfaces (e.g., one or more APIs).

The performance of certain of the operations may be distributed among various hardware processors, whether residing within a single machine or deployed across a number of machines. In some embodiments, the one or more hardware processors or engines may be located in a single geographic location (e.g., within a home environment, an office environment, or a server farm). In some embodiments, the one or more hardware processors or engines may be distributed across a number of geographic locations.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A processing server system configured to identify one or more classifications of an electronic form, the processing server system comprising:
one or more hardware processors; and
memory storing computer instructions, the computer instructions when executed by the one or more hardware processors configured to perform:
extracting information from raw source code and contextual information of an electronic form;
based on the extracted information, inferring the one or more classifications of elements on the electronic form;
based on the inferred one or more classifications of elements, inferring a classification of the electronic form;
suggesting a downstream action based on the inferred classifications of the elements and the inferred classification of the electronic form; and
selectively performing the downstream action.

2. The processing server system of claim 1, wherein the extracting of information further comprises extracting metadata of the electronic form, the metadata indicating previous versions or a lineage of the electronic form.

3. The processing server system of claim 1, wherein the computer instructions, when executed by the one or more hardware processors, are configured to perform determining one or more probabilities corresponding to the one or more inferred classifications of elements and the inferred classification of the electronic form.

4. The processing server system of claim 1, wherein the downstream action comprises autofilling or autocompleting one or more of the elements.

5. The processing server system of claim 1, wherein the contextual information comprises any textual features and media components within the electronic form, and relative positions of the any textual features and media components.

6. The processing server system of claim 1, wherein the contextual information comprises inferred or verified classifications of previous elements or forms of an immediately preceding form, wherein the immediately preceding form, following submission, populates the electronic form.

7. The processing server system of claim 1, wherein the inferring of the intent is performed by a trained machine learning component.

8. The processing server system of claim 1, wherein the computer instructions, when executed by the one or more hardware processors, are configured to perform:
detecting an update to the electronic form, the update comprising a new or modified element;
extracting information from raw source code and contextual information of the new or modified element;
based on the extracted information, inferring one or more classifications of the new or modified element;
based on the inferred one or more classifications of the new or modified element, inferring an updated classification of the electronic form;
suggesting a second downstream action based on the inferred classifications of the new or modified element and the updated classification of the electronic form; and
selectively performing the second downstream action.

9. The processing server system of claim 8, wherein the update to the electronic form is responsive to a change in an entity being monitored or tracked by the electronic form.

10. The processing server system of claim 8, wherein the update to the electronic form comprises an automatic switch between different versions of the electronic form at particular time intervals.

11. The processing server system of claim 8, wherein the update to the electronic form is in response to a user input or a user action within the electronic form.

12. The processing server system of claim 1, wherein the inferring of the one or more classifications of elements on the electronic form and the inferring of the classification of the electronic form are performed using one or more machine learning components, and the machine learning components are trained iteratively, using a first training dataset comprising previously inferred or verified classifications of elements and forms and a second training dataset comprising incorrectly inferred classifications of elements and forms by the machine learning components following the training using the first training dataset.

13. A processing server system configured to identify one or more classifications of an electronic form, the processing server system comprising:
one or more hardware processors; and
memory storing computer instructions, the computer instructions when executed by the one or more hardware processors configured to perform:
distributing a plugin to a client device, the plugin comprising a machine learning component that classifies one or more elements within an electronic form and classifies the electronic form;
receiving feedback from the client device regarding a performance of the machine learning component;
transmitting an indication to perform further training on the machine learning component based on the received feedback;
obtaining an updated machine learning component based on the further training; and
distributing a plugin having the updated machine learning component to the client device.

14. The processing server system of claim 13, wherein the feedback comprises erroneous inferences of classifications of elements or erroneous inferences of classifications of the electronic form.

15. The processing server system of claim 13, wherein the computer instructions, when executed by the one or more hardware processors, are configured to perform:
storing a trained machine learning component within the processing server system; and wherein the distributing of the plugin comprises determining or obtaining one or more storage or processing attributes or constraints of the client device; and selectively downscaling the machine learning component relative to the stored trained machine learning component based on the one or more storage or processing attributes or constraints of the client device.

16. A client device configured to identify one or more classifications of an electronic form, the client device comprising one or more hardware processors; and
memory storing computer instructions, the computer instructions when executed by the one or more hardware processors configured to perform:
receiving a plugin, the plugin comprising a machine learning component that classifies one or more elements within an electronic form and classifies the electronic form; and executing the plugin, wherein the executing of the plugin comprises:
extracting information from raw source code and contextual information of an electronic form;
based on the extracted information, inferring the one or more classifications of elements on the electronic form;
based on the inferred one or more classifications of elements, inferring a classification of the electronic form;
suggesting a downstream action based on the inferred classifications of the elements and the inferred classification of the electronic form; and
selectively performing the downstream action.

17. The client device of claim 16, wherein the extracting of information further comprises extracting metadata of the electronic form, the metadata indicating previous versions or a lineage of the electronic form.

18. The client device of claim 16, wherein the computer instructions, when executed by the one or more hardware processors, are configured to perform determining one or more probabilities corresponding to the one or more inferred classifications of elements and the inferred classification of the electronic form.

19. The client device of claim 16, wherein the downstream action comprises autofilling or autocompleting one or more of the elements.

20. The client device of claim 16, wherein the contextual information comprises any textual features and media components within the electronic form, and relative positions of the any textual features and media components.
